(19) United States
(12) Patent Application Publication
(10) Pub. No.: US 2005/0244161 A1
(43) Pub. Date: Nov. 3, 2005

(54) Optical transmission system, optical transmission and reception apparatus, optical transmission apparatus, optical wavelength channel connection recognition control method and wavelength allocation apparatus

(75) Inventor: Reiko Satoh, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/084,812

(22) Filed: Mar. 21, 2005

(30) Foreign Application Priority Data
Apr. 28, 2004 (JP) 2004-134682
Dec. 15, 2004 (JP) 2004-363183

(51) Int. Cl. H04J 14/02

(52) U.S. Cl. 398/85

(57) ABSTRACT

The present invention relates to an optical wavelength channel connection recognition control method. In an optical transmission system, a transmission section outputs plural monochromatic-wavelength lights individually, a first allocation section allocates a wavelength of a monochromatic-wavelength light based on a power of the monochromatic-wavelength light individually outputted from the transmission section from among the plural monochromatic-wavelength lights, a notification section issues a notification of wavelength information of the monochromatic-wavelength lights allocated by the first allocation section to the transmission section, and a first control section controls wavelengths of the monochromatic-wavelength lights to be outputted from the transmission section based on the wavelength information of the notification issued from the notification section. With this configuration, the optical transmission system becomes automated to significantly improve a convenience in channel allocation thereby to achieve simplification and improvement in efficiency of a cross connection function and reduction of a cost.

### BACKGROUND OF THE INVENTION

(1) Field of the Invention

The present invention relates typically to an optical transmission network apparatus, and more particularly to an optical transmission system, an optical transmission and reception apparatus, an optical transmission apparatus, an optical wavelength channel connection recognition control method and a wavelength allocation apparatus which can perform an automatic wavelength setting process, a control process and a cross-connection process for each of a plurality of wavelength channels (optical wavelength channels), suitable for use with a WDM (Wavelength Division Multiplexing) transmission system (hereinafter referred to simply as WDM transmission system).

(2) Description of Related Art

Generally, a WDM transmission system is used as a network for provision of a distribution service for distributing broadband data such as moving picture image data to a great number of network apparatus (network nodes) at the same time or as a network for connecting public agencies or cities. For the WDM optical transmission system, high-speed, great-capacity, high-quality and stable data transmission and flexibility ready for expansion of optical wavelength channels are required.

FIG. 21 is a diagrammatic view illustrating a distribution of wavelength channels. Referring to FIG. 21, the optical transmission system 500 shown is an optical transmission network system wherein a plurality of wide regions are connected to each other through optical fibers, optical amplification repeating apparatus and so forth to achieve long-distance, great-capacity, bi-directional and high-speed data transmission. The optical transmission system 500 includes transmission and reception blocks (network elements) NE-A1, NE-A2 and NE-E1 provided on transmission terminals of a network having a function of converting an electric signal of a packet etc. to light, or a function of multiplexing high-speedily a low-speed light and an electric signal to transmit/receive, wavelength division multiplexing and demultiplexing sections (MUX [multiplexing]/DEMUX [demultiplexing]) NE-B and NE-D, and n (n indicates natural number) transmission sections NE-C for transmitting wavelength division multiplexed lights (WDM lights) and performing an optical amplification repeating process or an add-and-drop process.

Transmission and reception sections A1#1 to A1#3 provided in the transmission and reception block NE-A1 transmit signal lights having unique wavelengths λ₁ to λ₃ set in advance, respectively, while a transmission and reception section A2#1 provided in the transmission and reception block NE-A2 transmits a signal light having a wavelength λ₄. In a case of transmitting electric signals such as packet signals including, for example, broadband data, the transmission and reception sections A1#1 to A1#3 and A2#1 EO-converts (Electrical to Optical conversion) the electric signals to be transmitted, into monochromatic-wavelength lights having the wavelengths λ₁ to λ₄, respectively.

In a case of transmitting low transmission speed electric signals or optical signals, the transmission and reception sections A1#1 to A1#3 and A2#1 multiplexes a plurality of the transmitting low transmission speed electric signals or optical signals for transmission, into signals having high transmission speed, and converts the signals into monochromatic-wavelength lights having the wavelengths λ₁ to λ₄.

Further, the signal lights having the wavelengths λ₁ to λ₄ are multiplexed by the wavelength division multiplexing and demultiplexing section NE-B. The wavelength division multiplexed lights propagates along the WDM transmission line and undergo, as occasion demands, a repeating and amplification or add-and-drop process by the transmission sections NE-C. Then, the wavelength division multiplexing lights are demultiplexed into signal lights having the wavelengths λ₁ to λ₄ by the wavelength division multiplexing and demultiplexing section NE-D.

The demultiplexed signal lights having the wavelengths λ₁ to λ₄ are OE-converted (Optical to Electrical conversion) or divided into low signals by transmission and reception sections E1#1 to E1#4 of the transmission and reception block NE-E1, respectively, and are distributed to access networks utilized by a plurality of users (for example, communication undertakers).

The users terminate the signal lights having the wavelengths λ₁ to λ₄ and repeat them to subscriber telephone networks, the Internet and so forth, or repeat the signal lights having the wavelengths λ₁ to λ₄ directly to different users (other communication undertakers to which lines are leased from communication undertakers or the like) without electrical terminating the signal lights. Further, wavelength division multiplexed lights can transmit through the WDM transmission lines bi-directionally.

Consequently, wavelengths of signal lights for transmission are individually allocated thereto, and transmitted and distributed.

The distribution of wavelength channels is described in more detail.

The transmission and reception block NE-E1 includes, as an example, 176 transmission and reception sections E1 (#1 to #176) for 176 wavelength division multiplexed lights. It is to be noted that, in the transmission and reception block NE-E1 shown in FIG. 21, monochromatic-wavelength lights for 4 channels from among the monochromatic-wavelength lights for some hundreds channels are shown. Though not shown, for example, a manager sells leases or registers the 176 monochromatic-wavelength lights to the users A to C. Consequently, for example, the channels #1 to #88, channels #89 to #143 and channels #144 to #176 are allocated to the user A, B and C, respectively. Further, the user A re-distributes the channels #1 to #44 and channels #45 to #88 to clients D and E, respectively.

In this manner, between the transmission and reception blocks NE-A1, NE-A2 and the wavelength division multiplexing and demultiplexing sections NE-B, NE-D and the transmission and reception block NE-E1 shown in FIG. 21, each signal light is fiber-connected individually, and a wavelength setting is suitably performed individually for the connected fibers.

Further, also in a WDM transmission apparatus, each of wavelength optical signals is individually monitored and controlled. In addition, an add/drop apparatus terminates/adds a transmission light having predetermined wavelength. Further, simplification upon construction of the WDM transmission system and facility in controlling, monitoring and maintenance of the individual WDM transmission apparatus are required significantly.

Therefore, generally for a wavelength management, (i) a method wherein a cross connect apparatus (an optical cross connect apparatus) for converting the wavelength of a signal light, for example, from a wavelength λ₁ into another wavelength λᵢ (i represents a natural number from 2 to 176), which is allocated on an optical port of a connected apparatus, in an optical wavelength region is provided, (ii) another method wherein OEO (Optical to E1ectrical to Optical: optic/electric/optic) conversion is used wherein a signal light having a wavelength λ₁ is converted once into an electric packet and the packet is modulated (converted) with signal light having a wavelength (for example, a wavelength λ₁₀₀) corresponding to a root (a physical port and/or an optical fiber) allocated in response to a transmission address of the packet and outputted, (iii) a further method wherein a manager manually connects optical fibers to a great number of ports placed in a transmission apparatus and sets wavelengths using a software command, and (iv) a still further method wherein a cross connect process is performed in an optical region in an add/drop apparatus provided in the WDM transmission system (transmission section NE-C shown in FIG. 21) etc. are used.

Herein, a meaning of the cross connect is to allocate input and output wavelengths fixedly with for example an input and output optical systems.

Meanwhile, a great number of techniques regarding a WDM transmission system have conventionally been proposed, and, for example, regarding distribution of optical wavelength channels, a technique is known wherein many and unspecified users distribute video data and so forth produced by them in a broadcasting manner to a great number of different users (refer to, for example, Patent Document 1). A network of the distribution selection type disclosed in Patent Document 1 solves the difficulty of control of the transmission timing, a transmittable band and so forth caused by sharing of network resources by a plurality of transmitters in a conventional network. Consequently, many and unspecified users can freely perform multicast communication.

Patent Document 1

Japanese Patent Application Publication Laid-Open (Kokai) No. 2000-253034

However, reviewing upon each of above methods (i)-(iv), the cross connect apparatus of item (i) and the add/drop apparatus of item (iv) are both very expensive, and where a case wherein the number of channels is small, or the number of channels or the arrangement of channels changes after operation of the system is started, is taken into consideration, in most cases the suitable cross connect apparatus etc. cannot be provided. Particularly where the cross connect function of item (iv) is provided in the WDM transmission system, the cost required for implementation of some hundreds of×some hundreds of cross connects for individually some hundreds of monochromatic-wavelength lights being currently used (in service) is extremely expensive and not realistic at all.

On the other hand, where the OEO conversion of item (ii) is used, expansion or reduction of the system cannot sometimes be performed appropriately. Accordingly, this technique has a subject to be solved in that a less expensive alternate apparatus to be used in place of a cross connect apparatus or the like is unavailable.

The OEO conversion of item (iii) has another subject to be solved in that, due to the complicatedness in connection and wavelength setting of optical fibers by manual operation, there is the possibility that an error in connection or in setting of a wavelength may occur and besides an increased cost is required for construction and for maintenance and management of the system.

On the other hand, the Patent Document 1 is silent of a technique for performing wavelength allocation, wavelength switching and so forth for each wavelength channel.

### SUMMARY OF THE INVENTION

It is an object of the present invention to provide an optical transmission system, an optical transmission and reception apparatus, an optical transmission apparatus, an optical wavelength channel connection recognition control method and a wavelength allocation apparatus wherein procedures for wavelength detection, wavelength setting and wavelength selection for a plurality of monochromatic-wavelength lights in a WDM transmission system included in an optical transmission system are automated to significantly improve the convenience in channel allocation thereby to achieve simplicity and improvement in efficiency of a cross connection function and reduction of the cost.

(1) In order to attain the object described above, according to an aspect of the present invention, there is provided an optical transmission system for multiplexing and transmitting a plurality of monochromatic lights having wavelengths different from each other, comprising a transmission section for outputting the plural monochromatic lights individually, a first allocation section for allocating a wavelength of a monochromatic light based on a power of the monochromatic light individually outputted from the transmission section from among the plural monochromatic lights, a notification section for issuing a notification of wavelength information of the monochromatic lights allocated by the first allocation section to the transmission section, and a first control section for controlling wavelengths of the monochromatic lights to be outputted from the transmission section based on the wavelength information of the notification issued from the notification section.

With the optical transmission system, if an optical fiber is connected, then optical connection in a channel of an object of setting is established automatically, and a plug-and-play function is implemented and besides improper connection can be excluded automatically. Therefore, manual correcting operation of a connection of an optical fiber is rendered unnecessary, and occurrence of an error in connection is prevented.

(2) Further, the first allocation section includes: a filter (a1) capable of being seta wavelength band including a wavelength of a desired monochromatic-wavelength light from among the plural monochromatic-wavelength lights to a pass band, or (a2) having a pass characteristic of the desired monochromatic-wavelength light; a detection section for detecting (b1) the power of monochromatic-wavelength light coincident with the pass band of the filter from among the plural monochromatic-wavelength lights individually sweep-outputted from the transmission section, or (b2) the power of monochromatic-wavelength light passing in accordance with a pass characteristic of the filter; and a second control section for allocating wavelengths of the monochromatic-wavelength lights outputted from the transmission section based on the power of the monochromatic-wavelength light detected by the detection section.

Configured as such, signal lights having wavelengths different from the specific wavelengths are blocked or disposed before signal lights are multiplexed. Consequently, an improper connection can be automatically detected, and a wavelength setting again become available.

(3) Furthermore, the optical transmission system further comprising: an allocation change detection section for detecting a change of an allocation regarding one or more monochromatic-wavelength lights from among the plural of monochromatic-wavelength lights; and the notification section issues a notification of the change of the allocation which is detected by the allocation change detection section to the transmission section.

(4) Additionally, the transmission section outputs white light including the individual wavelength bands of the plural monochromatic-wavelength lights and the detection section detects (b1) the power of a monochromatic-wavelength light coincident with the pass band of the filter from among the plural monochromatic-wavelength lights included in the white light outputted from the transmission section, or (b2) the power of monochromatic-wavelength light passing in accordance with a pass characteristic of the filter.

(5) Still additionally, above filter may have a wavelength band including a wavelength band of a desired monochromatic-wavelength light as a pass band.

Consequently, for example, a wavelength setting and connection correct/wrong (connection allowance/rejection) discrimination can be performed simultaneously and efficiently.

(6) Above filter may be capable of being set to a pass characteristic of a desired monochromatic-wavelength light.

Consequently, for example, the manager manually sets the pass band of the filter, which enables half automatic.

(7) Moreover, according to an another aspect of the present invention, there is provided an optical transmission system for multiplexing and transmitting a plurality of monochromatic-wavelength lights having wavelengths different from each other, comprising: a transmission section for outputting a plurality of monochromatic-wavelength lights or white light including individual wavelength bands of the plural monochromatic-wavelength lights; a second allocation section for allocating a channel of a monochromatic-wavelength light based on a power of a monochromatic-wavelength light individually outputted from the transmission section from among the plural monochromatic-wavelength lights or a power of the white light; a notification section for issuing a notification of wavelength information of the monochromatic-wavelength lights allocated by the second allocation section to the transmission section; and a first control section for controlling wavelengths of the monochromatic-wavelength lights to be outputted from the transmission section based on the wavelength information of the notification issued from the notification section.

(8) Still moreover, according to an other aspect of the present invention, there is provided an optical transmission system for multiplexing and transmitting a plurality of monochromatic-wavelength lights having wavelengths different from each other, comprising: a first optical transmission apparatus for outputting a plurality of monochromatic-wavelength lights having wavelengths different from each other; and a second optical transmission apparatus for multiplexing the plural monochromatic-wavelength lights outputted from the first optical transmission apparatus and transmitting the wavelength division multiplexed lights; the first optical transmission apparatus including: a transmission section for outputting the plural monochromatic-wavelength lights individually; a first reception section for receiving a notification including wavelength information of monochromatic-wavelength lights allocated in the downstream of the transmission direction side from among the plural monochromatic-wavelength lights from the downstream of the transmission direction side; and a first control section for controlling wavelengths of the monochromatic-wavelength lights to be outputted from the transmission section based on the wavelength information of the monochromatic-wavelength lights received by the first reception section, the second optical transmission apparatus including: a second reception section for receiving the monochromatic-wavelength lights individually outputted from the first optical transmission apparatus; a third allocation section for allocating a wavelength of a monochromatic-wavelength light based on a power of the monochromatic-wavelength light received by the second reception section from among the plural monochromatic-wavelength lights; and a notification section for issuing a notification of wavelength information of the monochromatic-wavelength lights allocated by the third allocation section to the first optical transmission apparatus.

(9) Still, according to an aspect of the present invention, there is provided an optical transmission and reception apparatus provided in an optical transmission system for multiplexing and transmitting a plurality of monochromatic-wavelength lights having wavelengths different from each other, comprising: a transmission section for outputting the plural monochromatic-wavelength lights individually; a first reception section for receiving a notification including wavelength information of monochromatic-wavelength lights allocated in a downstream of the transmission direction side from among the plural monochromatic-wavelength lights from the downstream of the transmission direction side; and a first control section for controlling wavelengths of the monochromatic-wavelength lights to be outputted from the transmission section based on the wavelength information of the monochromatic-wavelength lights received by the first reception section.

Consequently, since automatic wavelength setting is permitted after connection of an optical fiber, control, supervision and maintenance can be performed simply and conveniently and the facility can be improved significantly. Consequently, construction of an optical transmission system can be promoted.

(10) Furthermore, an optical transmission apparatus provided in an optical transmission system for multiplexing and transmitting a plurality of monochromatic-wavelength lights having wavelengths different from each other, comprising: a second reception section for receiving the monochromatic-wavelength lights individually outputted from the transmission side; a third allocation section for allocating a wavelength of a monochromatic-wavelength light based on a power of the monochromatic-wavelength light received by the second reception section from among the plural monochromatic-wavelength lights; and a notification section for issuing a notification of wavelength information of the monochromatic-wavelength lights allocated by the third allocation section to the transmission side.

With this, wavelength setting and connection correct/wrong or connection allowance/rejection discrimination can be performed simultaneously and efficiently based on the sweep control.

(11) In addition, the third allocation section includes: a filter capable of being set to a pass characteristic of a desired monochromatic-wavelength light from among the plural monochromatic-wavelength lights; a detection section for detecting the power of at least a monochromatic-wavelength light coincident with a pass band of the filter from among the plural monochromatic-wavelength lights individually sweep-outputted from the transmission side; and a second control section for allocating wavelengths of the monochromatic-wavelength lights based on the power of the monochromatic-wavelength light detected by the detection section.

(12) Moreover, the optical transmission apparatus further comprising: an allocation change detection section for detecting a change of a wavelength an allocation regarding one or more monochromatic-wavelength lights from among the plural of monochromatic-wavelength lights; and the notification section issues a notification of the change of the allocation which is detected by the allocation change detection section to the transmission section.

(13) Still more, according to an aspect of the present invention, there is provided an optical wavelength channel connection recognition control method between an optical transmission and reception apparatus and an optical transmission apparatus in an optical transmission system for multiplexing and transmitting a plurality of monochromatic-wavelength lights having wavelengths different from each other, comprising the steps of: at the optical transmission apparatus, transmitting a control request to the optical transmission and reception apparatus based on a connection of an optical fiber or a change of wavelength allocation in the downstream of the transmission direction side; at the optical transmission and reception apparatus, individually sweep-outputting the plural monochromatic-wavelength lights; at the optical transmission apparatus, monitoring the output power of a filter capable of setting a wavelength of a desired monochromatic-wavelength light as a pass band to detect the desired monochromatic-wavelength light; the optical transmission apparatus, issuing a notification of wavelength information of the detected monochromatic-wavelength light to the optical transmission and reception apparatus; and at the optical transmission and reception apparatus, outputting the desired monochromatic-wavelength light based on the wavelength information.

Consequently, a plurality of wavelengths can be automatically set at a time, and rapid and efficient wavelength setting can be achieved. Further, in a wavelength division multiplexing optical transmission apparatus, for example, when a transmission port is changed or a wavelength allocated to a transmission port is changed, a wavelength can be re-set. Furthermore, a re-configuration function for transmitting a designated wavelength from the optical transmission and reception apparatus and a detection function of an improper connection can be implemented.

(14) Further, according to an aspect of the present invention, there is provided a wavelength allocation apparatus provided in an optical transmission system for multiplexing and transmitting a plurality of monochromatic-wavelength lights having wavelengths different from each other, comprising: a transmission section for outputting the plural monochromatic-wavelength lights individually; a first allocation section for allocating a wavelength of a monochromatic-wavelength light based on a power of the monochromatic-wavelength light individually outputted from the transmission section from among the plural monochromatic-wavelength lights; a notification section for issuing a notification of wavelength information of the monochromatic-wavelength lights allocated by the first allocation section to the transmission section; and a first control section for controlling wavelengths of the monochromatic-wavelength lights to be outputted from the transmission section based on the wavelength information of the notification issued from the notification section.

With this, a connection condition of each wavelength can be detected and discriminated based on the connection detection whether wavelength setting or wavelength connection is correct or wrong, or should be allowed or rejected, automatic detection and automatic control of a wavelength or channel which do not rely only upon connection of an optical fiber by a maintenance, management or construction engineer and visual observation of software setting are implemented.

(15) The first allocation section includes: a second reception section for receiving the monochromatic-wavelength lights individually outputted from the transmission side; a filter capable of being set to a pass characteristic of a desired monochromatic-wavelength light from among the plural monochromatic-wavelength lights; a detection section for detecting the power of at least a monochromatic-wavelength light coincident with a pass band of the filter from among the plural monochromatic-wavelength lights individually sweep-outputted from the transmission section; and a second control section for allocating wavelengths of the monochromatic-wavelength lights based on the power of the monochromatic-wavelength light detected by the detection section.

(16) The notification section may issue the notification of the wavelength information of the monochromatic-wavelength light to the transmission section through an optical transmission line along which main signal light is transmitted.

Transmitted through an optical fiber for a main signal light, common use of the optical fiber can be achieved, for example.

(17) The notification section may issue the notification of the wavelength information of the monochromatic-wavelength light to the transmission section through a plurality of different ports individually corresponding to the plural ports.

Accordingly, for example, a reduction in cost for newly development is achieved, and the existing processing module for signal light can be available.

(18) The notification section may issue the notification of the wavelength information of the monochromatic-wavelength light to the transmission section through a communication line for network monitoring.

Accordingly, for example, if a fault occurs with the optical fiber for a main signal, a transmission line for a control signal is assured.

Further, for example, a plurality of linked operations can perform at the same time, and work in bi-directional transmission.

### BRIEF DESCRIPTION OF THE DRAWINGS

FIG. 1 is a diagrammatic view showing an example of a configuration of an optical transmission system to which the present invention is applied;

FIG. 2 is a diagrammatic view showing an example of networks according to the first embodiment of the present invention;

FIG. 3 is a diagrammatic view showing an example of a transmission interval of an optical transmission system according to a first embodiment of the present invention;

FIG. 4 is a diagrammatic view showing an optical transmission system which can perform bidirectional transmission according to the first embodiment of the present invention;

FIG. 5 is a schematic block diagram of an optical transmission and reception apparatus according to the first embodiment of the present invention;

FIG. 6 is a block diagram of a WDM transmission apparatus according to the first embodiment of the present invention;

FIG. 7 is a schematic block diagram of an another optical transmission and reception apparatus according to the first embodiment of the present invention;

FIG. 8 is a diagrammatic view showing a configuration of an allocation section according to the first embodiment of the present invention;

FIG. 9(a) is a diagrammatic view showing essential part of the wavelength allocation section according to the first embodiment of the present invention;

FIGS. 9(b) and 9(c) are diagrammatic views individually showing spectral patterns upon success in wavelength detection according to the first embodiment of the present invention;

FIGS. 9(d) and 9(e) are diagrammatic views individually showing spectral patterns upon failure in wavelength detection according to the first embodiment of the present invention;

FIGS. 9(f) and 9(g) are diagrammatic views individually showing spectral patterns upon success in wavelength detection according to a second modification to the first embodiment of the present invention;

FIG. 10 is a flow chart illustrating the optical wavelength channel connection recognition control method according to the first embodiment of the present invention;

FIG. 11 is a diagrammatic view for describing an example of the first linked operation according to the first embodiment of the present invention;

FIG. 12 is a diagrammatic view for describing an example of the second linked operation according to the first embodiment of the present invention;

FIG. 13 is a diagrammatic view for describing an example of the third linked operation according to the first embodiment of the present invention;

FIG. 14 is a flow chart illustrating a method of sweep control for the overall region wherein wavelength control is possible according to the first embodiment of the present invention;

FIG. 15 is a flow chart illustrating a method of sweep control performed every time a wavelength changes according to the first embodiment of the present invention;

FIG. 16 is a diagrammatic view showing a configuration of the wavelength allocation section according to a fourth modification of the first embodiment of the present invention;

FIG. 17 is an outline of a schematic block diagram showing an optical transmission and reception apparatus according to the fifth modification of the first embodiment of the present invention;

FIG. 18 is a diagrammatic view showing an example of a configuration of an optical transmission system according to the sixth modification of the first embodiment of the present invention;

FIG. 19 is a block diagram of the wavelength allocation section according to the second embodiment of the present invention;

FIG. 20 is a flow chart illustrating a method of sweep control upon wavelength re-setting according to the second embodiment of the present invention; and

FIG. 21 is a diagrammatic view illustrating distribution of wavelength channels.

### DESCRIPTION OF THE PREFERRED EMBODIMENTS

In the following, embodiments of the present invention are described with reference to the drawings.

(A) Description of the First Embodiment of the Present Invention

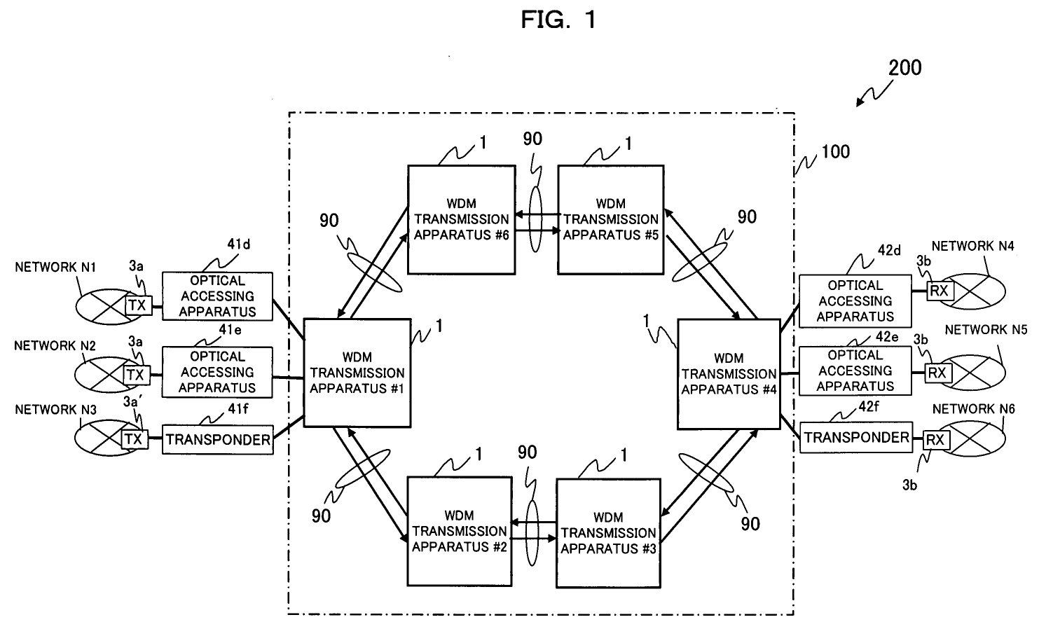

FIG. 1 is a diagrammatic view showing an example of a configuration of an optical transmission system (optical transmission network system) to which the present invention is applied. Referring to FIG. 1, the optical transmission system 200 shown performs multiplexing and transmitting a plurality of monochromatic lights having wavelengths different from each other. The optical transmission system 200 performs a wavelength division multiplexing process for signal lights, which is obtained by EO converting broadband data packets of moving picture image data or the like into any of the plurality of monochromatic-wavelength lights or obtained by converting lights having a low-transmission speed or electric signals, through bundling and high-speeding, into the monochromatic lights (single-wavelength lights), and performs a WDM transmission process for thus obtained multiplexed signal lights. Then, the optical transmission system 200 wavelength-demultiplexes the transmitted wavelength division multiplexed lights to convert the monochromatic-wavelength lights back into the original broadband data packets, or the low-transmission speed or electric signals.

This optical transmission system 200 includes a WDM transmission system (basic trunk type network system) 100 for wavelength-multiplexing the monochromatic-wavelength lights, and transmitting wavelength division multiplexed lights over a long distance and networks N1 to N6 provided, for example, in 6 regions and capable of accessing the WDM transmission system 100.

In the following description, while the number of wavelength is assumed to be, for example, 176, this number of wavelength can be available for various values. In addition, if further description is not made, the “176 monochromatic-wavelength lights” will be abbreviated to “each monochromatic-wavelength lights”. As described later, “176 transmission ports”, “176 reception ports” and “176 optical wavelength transmission units” or the like will be sometimes abbreviated to respectively “each transmission ports”, “each reception ports” and “each optical wavelength transmission units” or the like.

Transmission paths for information data in the optical transmission system 200 corresponds to, for example, paths between networks N1, N2, N3 side and networks N4, N5, N6 side, and a transmission direction is bi-directional.

Further, transmission paths for signal lights in the WDM transmission system 100 corresponds to mainly paths between the WDM transmission apparatus #1 and the WDM transmission apparatus #4. Mutual transmission paths between the WDM transmission apparatuses #2, #3, #5, #6 except for the WDM transmission apparatuses #1, #4, is the same as a WDM transmission path. Therefore, the transmission path between the WDM transmission apparatuses #1 and #4 and a cumulative description is omitted. Further, a direction of transmission of a wavelength division multiplexing light including information data and control data is bi-directional if a further description is not made.

Here, these six WDM transmission apparatuses 1 shown in FIG. 1 individually have specifications same as each other. When each of the WDM transmission apparatuses 1 is to be individually distinguished, six WDM transmission apparatuses 1 are hereinafter referred to individually as WDM transmission apparatuses #1 to #6.

(1) Optical Transmission System 200

(1-1) Networks N1 to N6

The networks N1, N2, N4 and N5 perform, as an example, the optical conversion process for packets including moving picture image data and so forth and output signal lights to the WDM transmission system 100 side, and the networks N3 and N6 may be configured to transmit signal lights modulated with dynamic picture image data and output the signal lights. Note that the interface between the WDM transmission system 100 and the networks N1 to N6 side is light or electricity.

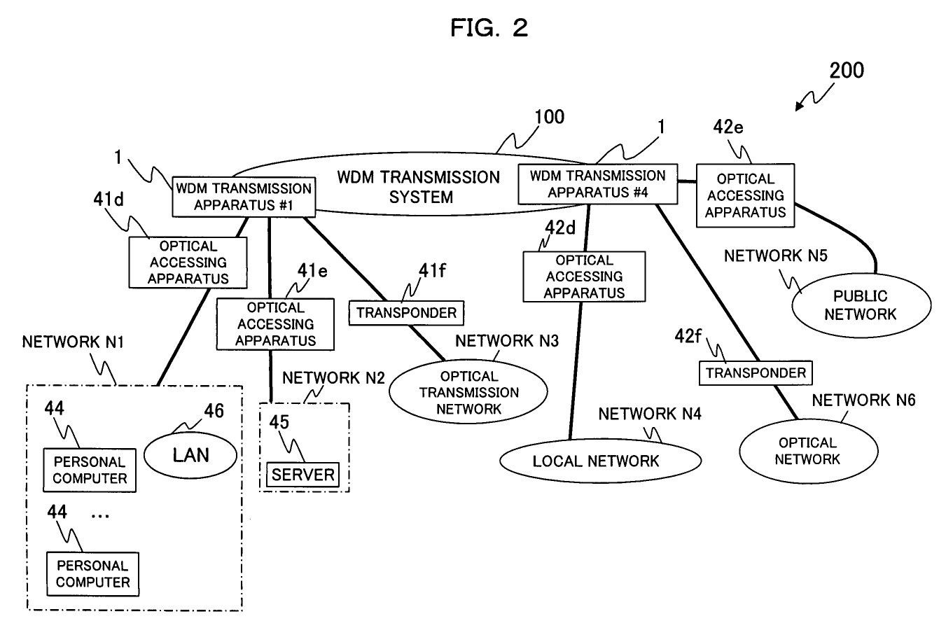

FIG. 2 is a diagrammatic view showing an example of the networks N1 to N6 according to the first embodiment of the present invention. Referring to FIG. 2, the network N1 shown is an access network which includes personal computers 44 used in enterprises, schools, homes and so forth and a LAN (Local Area Network) 46 and so forth, and is connected to the WDM transmission apparatus #1 through an optical accessing apparatus 41d which has a function of optical/electric conversion, and performs a high speed conversion process between MAC (Media Access Control) packets and signal lights. The network N2 is a public network having a function for performing a conversion process between IP (Internet Protocol) packets and signal lights between the WDM transmission system 100 and a server 45.

The network N3 is an optical transmission network such as, for example, a SONET/SDH (Synchronous Optical Network/Synchronous Digital Hierarchy) network. The network N4 is a local network provided in a large city. The network N5 is a public network. The network N6 is an optical network. It is to be noted that the networks N1 to N6 described above are an example, and the networks of the present invention are not limited to them. Functions of the networks N1 to N6 are hereinafter described.

A function for connecting each network N1-N6 and WDM transmission apparatuses #1, #4 will be described later.

(1-2) Optical Accessing Apparatuses 41d, 41e, 42d and 42e

Optical accessing apparatuses 41d and 41e for optically converting packets are connected to the networks N1 and N2 shown in FIG. 2, respectively. The optical accessing apparatuses 41d and 41e convert packets of the networks N1 and N2 into signal lights, respectively, and output the converted signal lights to the WDM transmission apparatus #1. Further, the optical accessing apparatuses 41d and 41e OE-convert signal lights received from the WDM transmission apparatus #1 into packets and transmit the converted packets to the networks N1 and N2.

Also optical accessing apparatuses 42d and 42e connected to the network N4 and N5, respectively, are similar to the optical accessing apparatuses 41d and 41e and are connected both of the networks N4 and N5 and the WDM transmission apparatus #4, respectively, and perform a conversion process between signal lights and packets. It is to be noted that the optical accessing apparatuses 41d and 41e and the optical accessing apparatuses 42d and 42e can be provided in the networks N1 and N2 and the networks N4 and N5, respectively.

(1-3) Transponders 41f and 42f

Transponders 41f and 42f individually have a function for converting a received signal light once into packets, extracting transmission source addresses and so forth, converting or modulating the packets into a signal light having an appropriate wavelength and then outputting the signal light based on the extracted transmission source address. The transponders 41f and 42f further have a function for adjusting the transmission speed of the converted packets and converting them back into a signal light and then outputting the signal light. The transponders 41f and 42f have wavelength-variable light sources provided therein. In shorts, the transponders 41f and 42f individually have an OEO conversion function.

Then, in the optical accessing apparatuses 41d, 41e, 42d, 42e or the transponders 41f, 42f, electrical/optical conversion is performed. Additionally, individual signals having, for example, 2.4 Gbps (giga bit per second) velocity are performed 4-multiplexing process, and the multiplexed signal is high-speedy multiplexed to obtain transmission speed 10 Gbps.

Note that, the optical transmission system 200 can be configured such that the WDM transmission system 100 and networks N1-N6 are directly connected, instead of setting an optical accessing apparatus 41d or the transponder and so on. In this configuration, a transmission and reception block be placed into a transmission terminal node in the WDM transmission system 100, and the block performs (i) an EO conversion or (ii) a transmission velocity conversion by high-speedy multiplexing a low-speed signal light and a low-speed electric signal to transmit and receive. Concerning a form of this direct connection, an explanation of this configuration is made in a sixth modification of first embodiment as described later.

Accordingly, the WDM transmission system 100 can connect (i) the optical accessing apparatuses 41d, 41e, 42d, 42e and (ii) the transponder 41f, 42f and (iii) many kinds of networks N1-N6, that is to say, the WDM transmission system 100 can connect any network system. Furthermore, the WDM transmission system 100 can promote to enlarge a transmission scale capable of transmitting and receiving signals and can reduce a transmission scale relatively with ease.

(1-4) Transmission Intervals in the WDM Transmission System (basic trunk WDM transmission line) 100

Referring to FIG. 1, for example, six WDM transmission apparatuses (optical transmission apparatuses of the present invention) #1 to #6 are connected in a ring through optical fibers 90, and thus formed the WDM transmission system 100.

The WDM transmission apparatuses #1 to #6 are provided in the optical transmission system 200. For example, the WDM transmission apparatuses #1 and transmit wavelength division multiplexed lights to other WDM transmission apparatuses #2 to #6 and transmit and receive monochromatic-wavelength lights to and from the optical accessing apparatuses 41d and so forth.

The WDM transmission apparatus #4 also transmits wavelength division multiplexed lights or monochromatic-wavelength lights to other WDM transmission apparatuses #1-#3, #5, #6 and transmit and receive monochromatic-wavelength lights to and from the optical accessing apparatus 42d and so forth.

The WDM transmission lines are configured such that, for example, the WDM transmission apparatuses #1 and #2 adjacent each other are connected to each other through two (or more than two) optical fibers 90 whose transmission directions are different from each other. The two optical fibers 90 are provided to transmit wavelength division multiplexed lights (main signal lights) produced by multiplexing monochromatic-wavelength lights including broadband data in a clockwise direction (WDM transmission apparatuses #1, #6, #5, #4, #3, #2, #1) and counterclockwise direction (WDM transmission apparatuses #1, #2, #3, #4, #5, #6, #1). Also signal lights for monitoring each WDM transmission apparatuses #1-#6 or for control (control lights, sub signal lights or OSC [Optical Supervisory Channel] lights: hereinafter referred to as control lights) are superposed on and transmitted together with the main signal lights.

Consequently, the WDM transmission apparatuses #1 to #6 can transmit and receive the wavelength division multiplexed lights to and from each other and the WDM transmission lines function as a basic trunk transmission line (also called as backbone).

It is to be noted that the WDM transmission system 100 is not limited to that of the ring type, but can be configured as a terminal-terminal (Term-Term) type transmission system for connecting a plurality of optical transmission and reception terminals (transmission terminals) provided in two regions which are distant over a long distance from each other.

It is to be noted that, similarly to the WDM transmission apparatuses #1 and #4, the WDM transmission apparatuses #2, #3, #5, and #6 can be configured such that they are connected to various kinds of networks through optical accessing apparatuses and transponders.

Further, the WDM transmission apparatuses #2, #3, #5, and #6 need not have function of wavelength division multiplexing/demultiplexing, and the WDM transmission system 100 may be configured by providing an amplification repeating apparatus which has function of wavelength division multiplexing/demultiplexing, in place of the WDM transmission apparatuses #2, #3, #5 and #6.

Now, elements denoted by reference characters 3a, 3b are described.

(1-5) Transmission Intervals Between the Networks N1-N3 and N4-N6 Through the WDM Transmission System 100

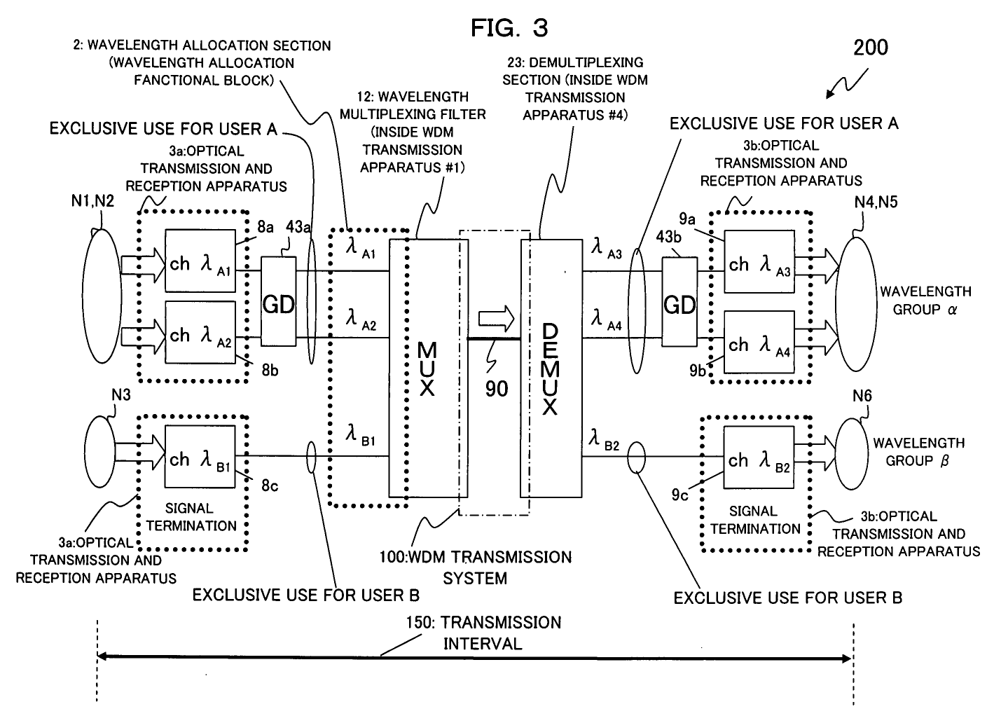

FIG. 3 is a diagrammatic view showing an example of transmission intervals of the optical transmission system 200 according to the first embodiment of the present invention. Referring to FIG. 3, in transmission intervals 150, data from the network N1 (or N2) is transmitted, using a wavelength of wavelength-group α, are transmitted to the network N4 (or N5), and data from the network N3 is transmitted, using a wavelength of wavelength-group β, to the network N6.

Here, on a transmission intervals of wavelength-group α, the network N1 (or N2), an optical transmission and reception apparatus (including a transmission section described later) 3a, the WDM transmission apparatuses #1, #4 and the optical transmission and reception apparatus 3b and the network N4 (or N5) are provided.

Meanwhile, the transmission interval β is formed from the network N3, an optical transmission and reception apparatus (optical transmission apparatus of the present invention) 3a′, the transponder 41f, the WDM transmission apparatuses #1 and #4, transponder 42f and the optical transmission and reception apparatus 3b′, and the network N6.

It is to be noted that, in the description of the optical transmission and reception apparatuses 3a, 3b and so forth, and sometimes an element (for example a module or an apparatus), which is not shown, is referred to, those elements not shown are the same as those shown in FIGS. 1 and 2 and so forth. Accordingly, unless otherwise specified, the number of drawing in which a not-shown numerical reference is shown (e.g. “see FIG. 1” or “refer to FIG. 1”) is sometimes omitted.

Each apparatus is hereinafter described. It is to be noted that details of the wavelength allocation section 2 (a wavelength allocation apparatus 4 or a functional block of wavelength allocation) shown in FIG. 3 are hereinafter described.

(i) Optical Transmission and Reception Apparatus 3a

The two transmission and reception apparatuses 3a are provided, respectively for wavelength-groups α, β, and the optical transmission and reception apparatus 3a for wavelength-groups α is provided between the network N1 or N2, and the WDM transmission apparatus #1.

When the optical transmission and reception apparatus 3a transmits electric signals like packet signals and so forth including, for example, a broad-band data, the optical transmission and reception apparatus 3a performs an optical conversion process (EO conversion process) for packets of the network N1 or N2 and transmits the converted signal lights to the WDM transmission apparatus #1 side. And the more, the optical transmission and reception apparatus 3a further performs a packet conversion process (OE conversion process) for a signal light from the WDM transmission apparatus #1 side and transfers the converted packets to the network N1 or N2.

In the meantime, when the optical transmission and reception apparatus 3a transmits electric signals having a low transmission velocity or optical signals, the optical transmission and reception apparatus 3a transmits signal lights, which are high-speedy multiplexed with a low signal of the network N1 or N2, to the WDM transmission apparatus #1 side. Further, the optical transmission and reception apparatus 3a forwards each signals, which is obtained by dividing signal light from the WDM transmission apparatus #1 side into a plural of low velocity signals, to the network N1 or N2.

In addition, the optical transmission and reception apparatus 3a for wavelength-groups β performs almost the same as the optical transmission and reception apparatus 3a for wavelength-groups α performs and an overlapping description thereof is omitted herein to avoid redundancy.

(ii) Optical Transmission and Reception Apparatus 3b

Meanwhile, two optical transmission and reception apparatus 3b respectively for wavelength-groups α, β is provided between the WDM transmission apparatus #4 and the network N3, N4 (or N5), and performs processes substantially same as those of the optical transmission and reception apparatus 3a. With this, the optical transmission and reception apparatus 3b performs a conversion process for conversion between packets and a signal light mutually with the network N4 (or N5) and transfers the converted signal light or packets to the WDM transmission apparatus #4 or the network N4 (or N5). In addition, the optical transmission and reception apparatus 3b for wavelength-groups β performs similarly to performances of wavelength-groups α, It is to be noted that the optical wavelength transmission and reception units 8a to 8c and optical wavelength transmission units 9a to 9c are hereinafter described.

(1-6) Example of Allocation of a Transmission Channel

The WDM transmission system 100 can allocate a transmission channel to a plurality of user. For example, a signal light of a wavelength λ_{A1} received by the WDM transmission apparatus #1 is connected to one of signal lights having wavelengths λ_{A3}, λ_{A4} and λ_{B2} through the WDM transmission apparatus #4 by the wavelength conversion process and the wavelength switching process. For instance, in each wavelength-group α, β shown FIG. 3, users A and B are allocated to channel λ_{A1} and channel λ_{B1}, respectively. Between the WDM transmission apparatuses #1 and #4, transmitted single wavelength division multiplexing light.

For example, users A and B (e.g. communication undertakers: otherwise three or more users may be involved) may each purchase (or lease, contract or the like) one or more channels included, respectively in wavelength-group α, β, from the manager (for example, communication undertaker, power undertaker or the like) of the WDM transmission system 100 and use the channels as channels for exclusive use.

In this manner, the present optical transmission system 200 includes an access system having the WDM transmission system 100 including formed from the WDM transmission apparatuses #1 to #6 and an accessing system formed from the networks N1 to N6, and the optical transmission and reception apparatuses 3a, 3b.

(1-7) Interfaces of WDM Transmission Apparatuses #1, #4

An interface between the WDM transmission apparatus #1 and the optical transmission and reception apparatus 3a, and an interface (signal interface or signal format) between the WDM transmission apparatuses #1, #4 is an optical signal, the wavelength of which can be wavelength-multiplexed in WDM transmission apparatuses #1, #4. In another words, various modulation schemes of light signal can be available, and are different from an interface with directly the WDM transmission apparatus #1.

It is to be noted that interfaces between each network N1-N6 and the optical wavelength transmission and reception units 8a to 8c and 9a-9c (refer to FIG. 3 and so forth) signal termination and wavelength termination are performed depending upon transmission contents (transmission information) in accordance with several protocols such as the SONET, MPEG (Moving Picture Coding Experts Group/Moving Picture Experts Group), TCP/IP (Transmission Control Protocol/Internet Protocol) etc.

(1-8) Example of Bi-directional Transmission

Further, on the WDM transmission line, a signal light can transmit signal lights bi-directionally.

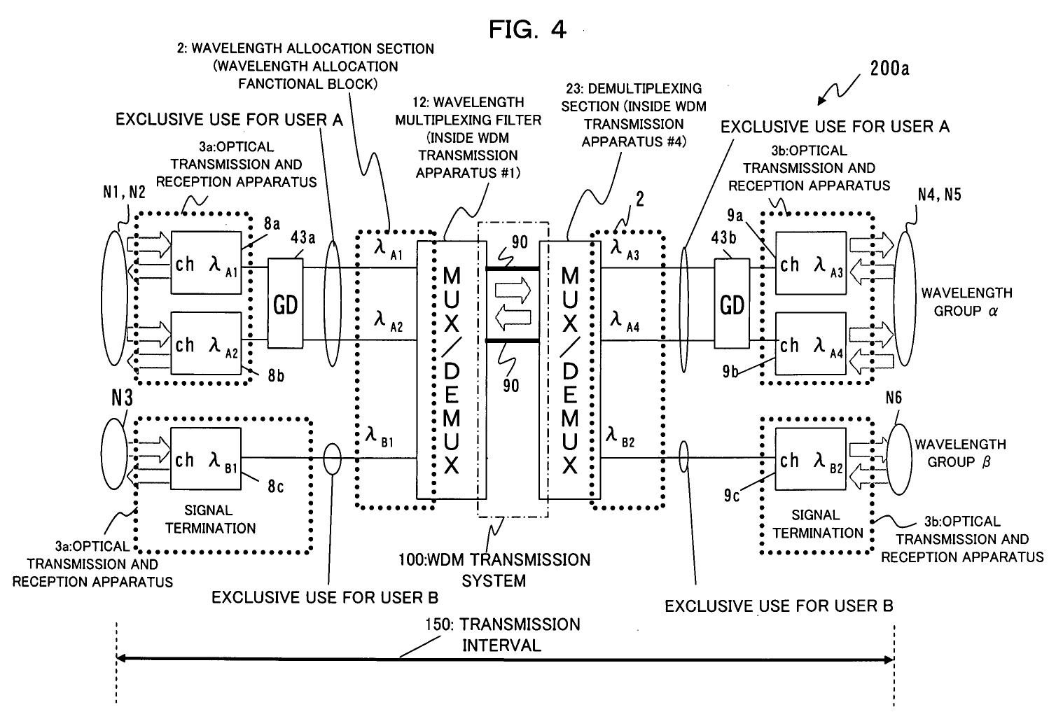

FIG. 4 is a diagrammatic view showing an example of an optical transmission system 200a which can perform a bi-directional transmission process according to the first embodiment of the present invention. Elements provided in the optical transmission system 200a shown in FIG. 4 have transmission and reception functions similarly as in those of the apparatuses shown in FIG. 3.

Consequently, when packets from the network N4 is sent to network N1, the optical wavelength transmission and reception apparatus 3b for wavelength-group α, converts a great number of packets in the network N4 into signal lights having wavelengths λ_{A1} and λ_{A2} and transmit the converted signal lights to the WDM transmission system 100. Further, signal lights having wavelength λ_{A3} and λ_{A4} are converted into signal lights having wavelength λ_{A1} and λ_{A2} in the WDM transmission system 100, and each converted signal light is OE-converted in the optical wavelength transmission and reception apparatus 3a, and the OE-converted packets are forwarded to the network N1.

On the other hand, when the optical wavelength transmission and reception apparatus 3b, different from a packet transmission, multiplexes low-speed signals having a small velocity to transmit, the low-speed signals from the network N4 are multiplexed to be high-speed signal in the optical wavelength transmission and reception apparatus 3b. This high-speed signal is converted into two monochromatic-wavelength lights having wavelengths λ_{A3}, λ_{A4}, respectively, and thus converted monochromatic-wavelength lights having wavelengths λ_{A3}, λ_{A4} are transmitted to the WDM transmission system 100 side.

Furthermore, in an interface portion between the network N1 and the WDM transmission apparatus #1, each wavelength division multiplexed light is demultiplexed as monochromatic-wavelength lights having wavelengths λ_{A1}, λ_{A2} respectively, and thereafter the demultiplexed monochromatic-wavelength lights are divisionally converted into low-speed signals, and these divisionally-converted original low-speed signals are forwarded to the network N1.

Note that a reverse-direction transmission of a wavelength-group β is the same as a reverse-direction transmission of a wavelength-group α, and redundant description is omitted.

(2) Configuration of Present Optical Transmission and Reception Apparatus 3a

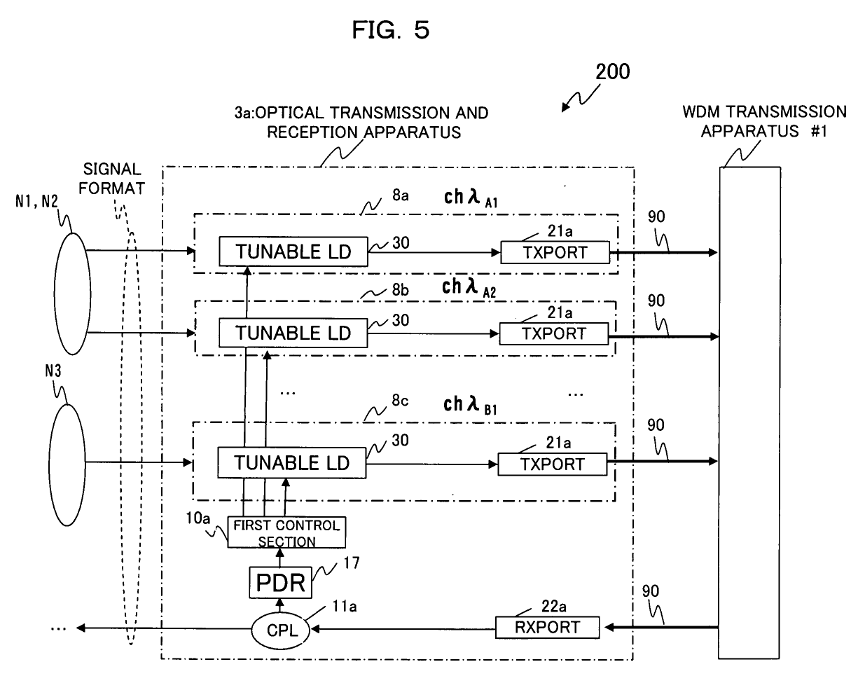

FIG. 5 is a schematic block diagram of the optical transmission and reception apparatus 3a according to the first embodiment of the present invention. Referring to FIG. 5, the optical transmission and reception apparatus 3a shown includes optical wavelength transmission units (transmission sections) 8a to 8c, a first control section 10a, a coupler (CPL [Coupler]: optical coupler or reception section) 11a, a photodiode (PDR [PD for Reception]: a first reception section or optical reception means) 17, and a reception port (RXPORT) 22a.

(2-1) Processing of Signal Lights Transmitting in Reverse Direction the Transmission Direction

The reception port 22a is a physical port or optical connector to receive a signal light. Couplers 11a is for dividing (branching) a monochromatic-wavelength light from the WDM transmission apparatus #1, and for extracting a control signal. It is to be noted that a receiving module of which a Multiplexing/Demultiplexing function and an optical detection are integrated in place of couplers 11a.

The photodiode 17 is for receiving a notification, from a downstream of a transmission direction side) included wavelength information (concretely, wavelength information like ch λ_{A1}, ch λ_{A2}, ch λ_{B1}) of each monochromatic-wavelength light concerning the optical wavelength transmission and reception apparatus 3a allocated in the WDM transmission apparatus #1 side among each of the monochromatic-wavelength light. The photodiode 17 serves as a first reception section.

Further, photodiode 17 is an optical signal detector for detect a main signal light and a control light, and a wavelength information included in the control light represents a wavelength information (information representing any wave among wavelength λ₁ to λ₁₇₆), of a wavelength information detected in the WDM transmission apparatus #1 of each monochromatic-wavelength light sweep-outputted by a transmission section (tunable laserdiode 30 [later described wavelength variable optical transmission means]). Still further, the photodiode 17 inputs, for example an electric signal obtained by a detection of the control light, to next described a first control section 10a. The first control section 10a processes the electric signal and controls, for example, a change of transmission wavelength. Yet further, as an example of changing of wavelength, the first control section 10a can change, set a wavelength channel at the time, a wavelength channel of short wavelength side, and a wavelength channel of long wavelength side.

Here, there are a plurality of ways to change a wavelength to be transmitted or to determine a width of changing each wavelength channel (wavelength channel width to be changed) to be changed or set. For example, the present optical transmission system 200 can use a method for (i) setting channel interval of each wavelength channel, or (ii) setting beforehand-determined wavelength in accordance with a wavelength of a receiving light. In short, each wavelength channel is shifted upward per each channel, or shifted downward per each channel.

Next, the photodiode 17 functions as a part (or an element) of a function of signal process in the WDM transmission apparatus #1. The functions of this photodiode 17 can be realized by using a flexibility small-sized transmitting/receiving module. The function as the first reception section can also realize by using a reception process section or a receiving module inside the transmitting/receiving module.

The first control section 10a, controls wavelengths of a monochromatic-wavelength light outputted from any of the optical one or more wavelength transmission units (transmission sections) 8a to 8c based on wavelength information notified from a notifying section (described later) placed in the WDM transmission apparatus #1. A concrete example of control is that the first control section 10a, sets a wavelength of the signal light outputted from the optical wavelength transmission units 8a to 8c, to a received detected wavelength (for example 100). A function of the first control section 10a, is realized by a control function circuit etc. , the control function circuit is combined with a CPU (Central Processing Unit), a ROM (Read Only Memory), a RAM (Random Access Memory) and so forth.

(2-2) Processing of Signal Light Transmitting in Reverse Direction

The optical wavelength transmission units 8a and 8b are for outputting the plural monochromatic-wavelength lights individually, and functions as a transmission section. In concrete, the optical wavelength transmission units 8a to 8c convert packets etc. transmitted from the networks N1 and N2 (refer to FIG. 1 etc.) into signal lights having wavelengths, for example, λ_{A1} and λ_{A2}, respectively, and transmit the converted signal lights to the WDM transmission apparatus #1 side. Moreover, the optical wavelength transmission units 8c converts packets etc. transmitted from the networks N3 into signal light having wavelength, for example, λ_{B1}, and transmits the converted signal light to the WDM transmission apparatus #1 side.

It is to be noted that the optical wavelength transmission units 8a, 8a transmit a signal light (wavelength division multiplexing light), in which a low-speed signal of the network N1 or N2 is high-speedy multiplexed, into the WDM transmission apparatus #1. The optical wavelength transmission unit 8c transmits a signal light, in a low-speed signal of the network N3 is high-speedy multiplexed.

Here, the optical wavelength transmission units 8a to 8c can change an output light wavelength, and they include one or more transmission port (TXPORT) 21a and a tunable laser diode (tunable LD) 30. The transmission port 21a is a physical port or an optical connecter, and is connected the optical fiber 90, removablelly.

Further, the tunable laser diode 30 is for output the monochromatic-wavelength light outputs/transmits a desired wavelength, and capable sweep output which change a wavelength of the monochromatic-wavelength light. A function of the tunable laser diode 30 can be implemented by a transmission and reception module (not shown), in which transmitting function and receiving function are combined and having a general-purpose small sized (for example approximately 3-10 cm). Further, a transmission processing section or a transmission module, provided inside the transmission and reception module, may change a wavelength of the monochromatic-wavelength light, and output a monochromatic-wavelength light with a wavelength of the monochromatic-wavelength light being changed.

It is to be noted that each function of optical detection of the photodiode 17 and function of optical transmitting can be realized by a transmission and reception module (not shown) which combines both functions.

Further, signals inputted to the optical wavelength transmission units 8a to 8c are, for example, electric packets. Not only these electric packets but also signals having various signal formats can be implemented. The signal formats can be processed according to functions of the optical transmission and reception apparatuses 3a, 3b.

(2-3) Channels

Here, in FIG. 3, two optical wavelength transmission units 8a and 8b are both provided for user A. User A re-distributes these optical wavelength transmission units 8a and 8b to, for example, clients C, D, respectively, and uses to EO-convert, for instance, packet signals from each clients C and D. In other words, each optical wavelength transmission unit 8a or 8b functions each as a signal termination apparatus for terminating a packet signal from the client C or D and converting the packet signal into a signal light.

(2-4) Mode in Which a Grouping Process is Added

As user A re-distributes channels for a plurality of (here two) clients C and D, the channels for clients C and D need to be allocated efficiently. Note that the number of clients, as shown in FIG. 3, are two, and one channel is allocated for clients C, D.

Where, the grouping processing section 43a performs a wavelength switching process for wavelengths of each signal light individually outputted from the optical wavelength transmission unit 8a and 8b, to other wavelengths different from those wavelengths , and modulates and demodulates information data included in the signal light before the wavelength switching. After demodulation, the grouping processing section 43a modulates the information data to a signal light after wavelength switching, and transmits the modulated signal light to a WDM transmission apparatus #1 side. A grouping processing section 43b performs a wavelength switching process for wavelengths of each signal light, and modulates and demodulates information data included in the signal light before the wavelength switching.

The grouping processing sections 43a and 43b are processed such that a wavelength of transmission light and a wavelength of reception light corresponding in 1 to 1, and are provided in a place which does not influence on a sweep operation to detect wavelengths, and need to prevent a terminating as a pass of a transmission light. Further, the grouping processing sections 43a and 43b (not shown) which wavelength-switches signal lights having wavelengths λ_{A3}, λ_{A4} outputted from the WDM transmission apparatus #4 may be provided. Each of the grouping processing sections 43a and 43b functions as an exchanger (exchanging apparatus) for optical paths which switch wavelengths of signal lights having wavelengths λ_{A3}, λ_{A4} by cooperating with each other.

With this, a controlling of wavelength allocation can be carried out together by each group, and a load of a control process becomes lower.

Here, wavelength switching means wavelength switching (wavelength selective switching or wavelength routing) the signal lights wavelengths λ_{A1} or λ_{A2} in optical band area.

Accordingly, the optical transmission system 200 (or 200a) can be applied to other optical transmission of other optical transmission system which is configured to perform grouping process such as a switching of a transmission route of signal light, without providing wavelength conversion process. Further, the grouping process can be applied, for example, if grouping processing sections 43a and 43b are provided between the optical transmission and reception apparatus 3a and the WDM transmission apparatus #1. Accordingly, the wavelength setting process and so forth become automated, and simplification and improvement in efficiency of the wavelength switching function can be anticipated. Consequently, reduction of the cost can be achieved.

(3) WDM Transmission Apparatus #1

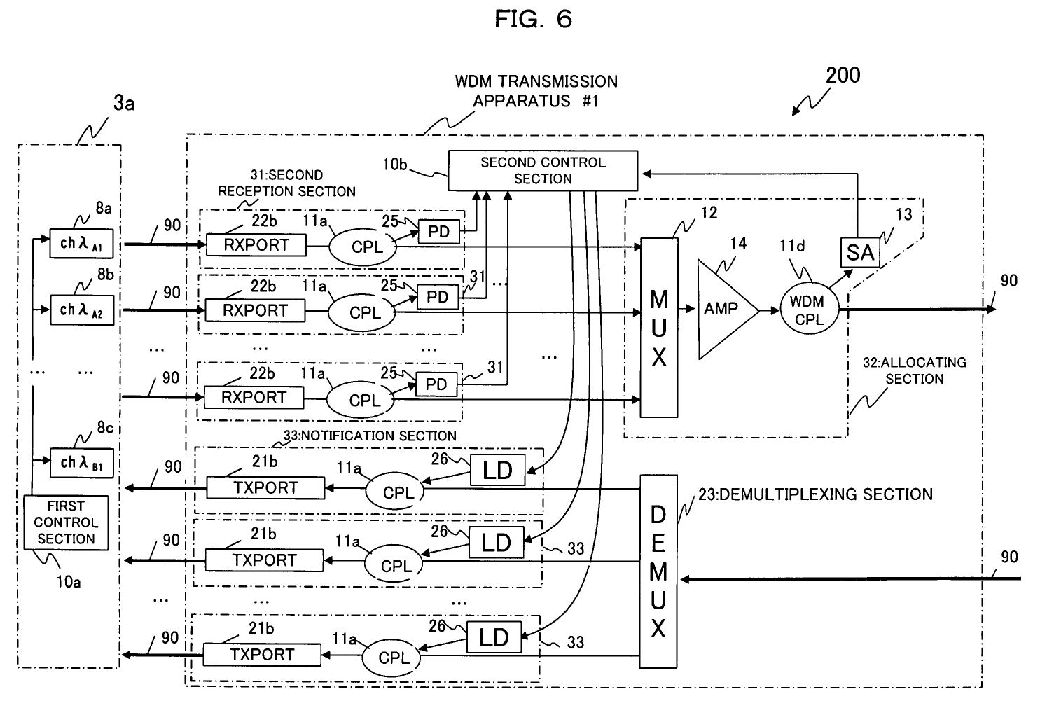

FIG. 6 is a block diagram showing the WDM transmission apparatus #1 according to the first embodiment of the present invention. Referring to FIG. 6, the WDM transmission apparatus #1 shown includes a demultiplexing section (DEMUX) 23, a notification section 33, a second reception section 31, an allocation section (a wavelength allocation apparatus or a wavelength allocation function block) 32, a second control section 10b.

Both of the demultiplexing section 23 and the notification section 33 process signal lights transmitted in the reverse direction to the transmission direction, and both of the second reception section 31 and the allocation section 32 process signal lights transmitted in the transmission direction, and the second control section 10b processes signal lights transmitted in both directions.

(3-1) Processing of Signal Lights Transmitting in Reverse Direction the Transmission Direction

By a cooperation of the demultiplexing section 23 and the notification section 33, a control information is notified to the optical transmission and reception apparatuses 3a to 3c. Note that the optical transmission and reception apparatuses 3b, 3c have the same configurations of the optical transmission and reception apparatus 3a, a redundant description thereof is omitted herein.

Process signal lights transmitted in the reverse direction to the transmission direction, and both of the second reception section 31 and the allocation section 32 process signal lights transmitted in the transmission direction, and the second control section 10b processes signal lights transmitted in both directions.

The demultiplexing section 23 demultiplexes a received wavelength multiplexing light to included monochromatic-wavelength lights, and demultiplexes the wavelength multiplexing light from the adjacent WDM transmission apparatus #2 or #6 (FIG. 1 etc.), input the demultiplexed monochromatic-wavelength lights to a plurality of the notification sections 33.

Further, the notification section 33 issues a notification of wavelength information of the monochromatic-wavelength lights allocated by the allocation section 32 to the optical wavelength transmission units (transmission sections) 8a to 8c, and comprising transmission ports 21b, coupler (optical coupling means) 11a, laserdiode 26. The transmission port 21b is a physical port or optical connector to transmit a signal light. Coupler 11a is for dividing (branching) a main signal light from the demultiplexing section (DEMUX) 23 and a signal light from the laserdiode 26. The laserdiode 26 outputs a control light modulated by a control signal (detection wavelength information etc.) from the second control section 10b. Further, in place of the laserdiode 26, a modulator (not-shown) which outputs a control light, can be used.

Now, an example of driving a signal light using the laserdiode 26 or the modulator is further described.

A function of the laserdiode 26 or the modulator is realized by a signal light source module etc. This signal light source module is a device to notify wavelength information determined at described later a second control section 10b and other control information to the optical wavelength transmission units 8a, 8b side.

In the meantime, the WDM transmission apparatus #1 may be configured to transmit the wavelength information corresponding to a plurality of (for example two) the optical wavelength transmission units 8a, 8b, by using one laserdiode 26 or one modulator etc. which is for superposing the control signal.

On the other side, the WDM transmission apparatus #1 may be configured to transmit the wavelength information corresponding to, for example, two optical wavelength transmission units 8a, 8b, by using one laserdiode 26. The function of this laserdiode 26 may be realized by using a transmission process section or a transmission module provided in, for example, a small-sized transmission and reception module.

Further, the function of the laserdiode 26, which is for superpose a control signal to main signal, or the modulator etc. may be realized by a transmission process section (not shown) or a transmission module (not shown) provided in, for example, a small-sized transmission and reception module.

With this configuration, the plurality of main signal lights (monochromatic-wavelength lights) are inputted to a plurality of the coupler 11a, respectively, and in each coupler 11a, the control light from the laserdiode 26 modulated with the control signal from the second control section 10b and the main signal light from the demultiplexing section 23 are multiplexed. Further, from each coupler 11a, signal lights, superposed on the main signals and the control signals, are outputted and transmitted networks N1-N6 side through the optical fiber 90.

In this way, the control information is notified from the WDM transmission apparatus #1 to the optical transmission and reception apparatuses 3a to 3c.

(3-2) Second Control Section 10b

The second control section 10b is for allocating wavelengths of the monochromatic-wavelength lights outputted from the optical transmission and reception apparatuses 3a to 3c of the transmission side based on the power of the monochromatic-wavelength light detected by the allocation section 32.

In concrete, the second control section 10b allocates wavelengths of the monochromatic-wavelength lights outputted from the optical transmission and reception apparatus 3a of the transmission side, based on the powers of the monochromatic-wavelength lights detected by the plurality of the second reception section 31 and the powers of the monochromatic-wavelength lights detected by the allocation section 32, and provides an updatable memory (not shown) storing data needed for the wavelength allocation control. In this memory, at least next three kinds of data (i)-(iii) are written and stored.

(i) each measurement data of a detected channel and a detected power in the WDM transmission apparatus #1.

(ii) data concerning a channel blocking for discriminating an idle condition or an operating condition of all channels.

(iii) data representing a relationship between a detected channel and an allocated channel, for example, “when the detected channel is channel #1, the channel to be allocated is channel #88” etc.

Each data described by these (i)-(iii) is one example and the present invention is not limited to these data, items etc.

The second control section 10b, in addition to the function of the wavelength allocation, may be configured to cut off or abandon the signal light having wavelength other than the detection target before the multiplexing. Where the second control section 10b is configured in this manner, the WDM transmission apparatus #1 can detect an improper connection and re-set a wavelength, thus carry out the wavelength detection still in certain.

Note that the second control section 10b further comprises a function of generating a wavelength information and control information which is transmitted to the optical transmission and reception apparatus 3a side.

(3-3) Signal Light Transmitted in the Downstream of the Transmission Direction Side

Next, the second reception section 31 is for receiving the monochromatic-wavelength lights (the monochromatic-wavelength lights individually outputted from the transmission side) from the optical transmission and reception apparatus 3a (or the optical wavelength transmission units 8a to 8c as shown in FIG. 5), and includes reception ports 22b, photodiodes (optical receiving means: PD) 25, couplers (optical branching means: CPL) 11a. Each reception port 22b is provided individually for wavelengths λ₁ to λ₁₇₆, and allow removable connection of the optical fibers 90 thereto.

The photodiode 25 functions as a light intensity measuring instrument which receives light (for example individually outputted monochromatic-wavelength light) from the transmission-side optical transmission and reception apparatus 3a, and is a device which outputs electric current in response to an average intensity of received light. For example, a transmission-type photodiode (TAPD etc.) can be used for the photodiode 25. TAPD is a double core type transmission-type photodiode and is mainly for detecting an intensity of a received light, and can detect the intensity of the received light without using an intensity-branched light in the coupler 11a. With this, whether or not of an inputted light in a reception port 22b is monitored.

Further, an optical amplifier (not shown) can be provided on a signal line from a reception port 22b to the second control section 10b in an allocation section 32 as occasion demands. Furthermore, a cooperation of the coupler 11a, the photodiode 25 and an optical amplifier, can sense an optical intensity, and notify an optical input to the second control section 10b. The coupler 11a etc. are provide from a position of later described a wavelength multiplexing filter (optical multiplexing means or wavelength multiplexing means) 12.

With this, the second control section 10b can obtain information concerning light intensities of each monochromatic-wavelength lights from the optical transmission and reception apparatus 3a. Noted that components illustrated in FIG. 6, attached with the same reference numerals as those of the components of the above-described embodiment have the same.

(3-4) Function of Wavelength Allocation.

Next, the allocation section 32 for allocating a wavelength of a monochromatic-wavelength light based on a power of the monochromatic-wavelength light individually outputted from the transmission section from among the plural monochromatic-wavelength lights, and comprises a spectrum analyzer (detection section: spectrum analyzer unit SAU) 13 as an optical intensity detection means, an optical amplifier 14, a wavelength multiplexing filter (MUX) 12, a WDM coupler (optical branching means: a coupler for WDM signals) 11d.

The spectrum analyzer 13 is for detecting (or monitoring) the power of monochromatic-wavelength light coincident with the pass band of the wavelength multiplexing filter 12 from among the plural monochromatic-wavelength lights individually sweep-outputted from the transmission-side optical wavelength transmission unit (transmission sections) 8a to 8c, or the power of monochromatic-wavelength light passing in accordance with a pass characteristic of the wavelength multiplexing filter 12, and functions also as a detection section (a detection means) for detecting the optical intensity of each wavelength. Moreover, the spectrum analyzer 13 outputs a various measurement data of the optical spectrum such as the wavelength position, wavelength band (optical spectrum width), wavelength distribution and power of the distributed optical spectra to the second control section 10b.

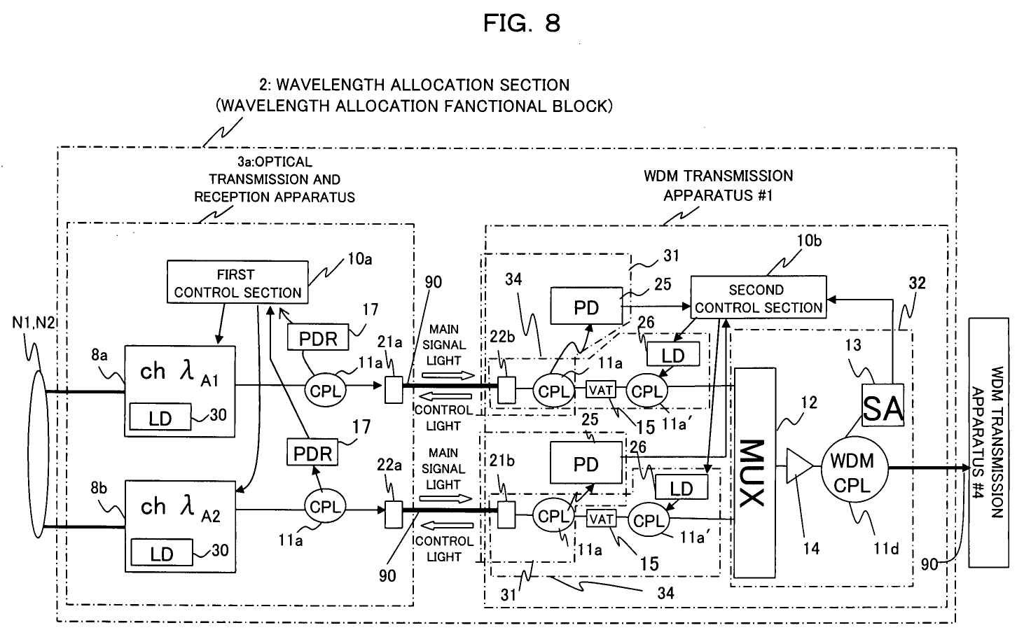

Further, an optical amplifier 14 is for amplifying the powers of wavelength division multiplexing lights outputted from the wavelength division multiplexing filter 12, and this amplifying function can be achieved by a various amplifying means. The optical amplifier 14 is provided at desired position in the WDM transmission apparatus #1 as occasion demands to amplify the power of each signal light or wavelength division multiplexing lights. Still additionally, an optical attenuator is provided at desired position (for example described later in FIG. 8 etc.).

(3-5) Wavelength Multiplexing Filter 12

The second control section 10b is given a function of setting a pass band of the wavelength division multiplexing filter 12.

The wavelength division multiplexing filter 12 is a filter which has a transmission characteristic (wavelength band characteristic after passage of a filter) of a desired monochromatic-wavelength light from among the plural monochromatic-wavelength lights, and can operate in two modes (hereinafter referred to as first mode and second mode). The first mode is that the wavelength division multiplexing filter 12 has a wavelength band including a wavelength band of a desired monochromatic-wavelength light as a pass band. The second mode is that the wavelength division multiplexing filter 12 is capable of being set to a pass characteristic of a desired monochromatic-wavelength light.

Moreover, the second control section 10b obtains an optical power information of each monochromatic-wavelength light from the second reception section 31 as well as an optical power information of each wavelength included in the wavelength division multiplexed light from the spectrum analyzer 13. With this, when the spectrum analyzer 13 detects an optical power of desired wavelength λ, and the second reception section 31 detects an optical power corresponding to , for example, the second reception port 22b, the second control section 10b, based on these information, recognizes that a light having wavelength λ is outputted from the second reception port 22b.

Here, an optical amplifier 14 is for amplifying the powers of wavelength division multiplexing lights outputted from the wavelength division multiplexing filter 12. This amplifying function can be achieved by a various amplifying means.

The optical amplifier 14 is provided at desired position in the WDM transmission apparatus #1 as occasion demands to amplify the power of each signal light or wavelength division multiplexing lights, and additionally an optical attenuator is provided at desired position.

(4) Optical Transmission and Reception Apparatus 3b and WDM Transmission Apparatus #4

(4-1) the Optical Transmission and Reception Apparatus 3b

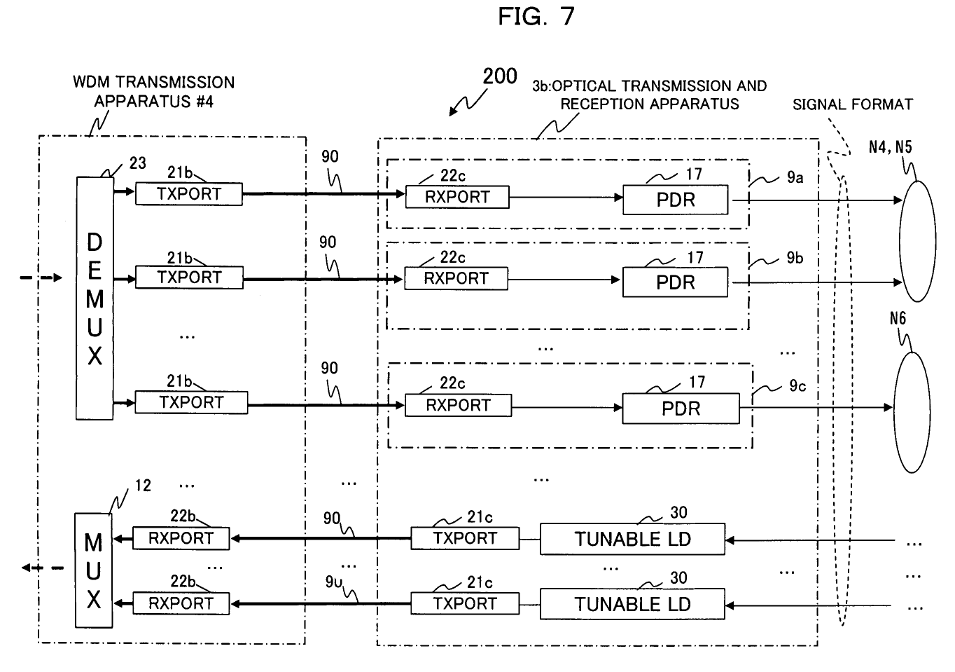

FIG. 7 is a schematic block diagram of another optical transmission and reception apparatus 3b according to the first embodiment of the present invention. Referring to FIG. 7, the optical transmission and reception apparatus 3b shown includes a optical wavelength reception units 9a-9c. Note in FIG. 7 that the parts with the same reference numerals as described above have the same function, and redundant description is omitted.

The optical wavelength reception units 9a and 9b OE-convert signal lights of wavelengths λ_{A3} and λ_{A4} received from the WDM transmission apparatus #4, and transfer OE-converted packets to the network N4 or N5 (FIG. 1 etc.), respectively. Each of the optical wavelength reception units 9a and 9b includes a reception port 22c and a photodiode 17.

The optical wavelength reception unit 9c (i) converts a received signal light of the wavelength λ_{B2} into an electric signal, (ii) converts a low-speed optical signal into an electric signal, or (iii) converts a data format of a frame or a signal having a some signal etc., into a desired signal to output. The wavelength switched signal light is transferred to the network N6.

Note that signal formats outputted from the optical wavelength reception units 9a-9c can be available not only an optical signal but also a signal format which the optical transmission and reception apparatus 3b can process in accordance with the function of the optical transmission and reception apparatus 3b.

(4-2) WDM Transmission Apparatus #4

Further, the configuration of the WDM transmission apparatus #4 shown in FIG. 7 is the same as the WDM transmission apparatus #1.

In the WDM transmission apparatus #4, the wavelength multiplexing light is demultiplexed to each monochromatic-wavelength light, each a monochromatic-wavelength light is transmitted to the optical transmission and reception apparatus 3b through the transmission port 21b in the WDM transmission apparatus #4, respectively. Regarding a reverse direction, each a monochromatic-wavelength light is outputted from each transmission port 21c of the optical transmission and reception apparatus 3b, and is multiplexed in the wavelength multiplexing filter 12 through the reception port 22b of the WDM transmission apparatus #4.

With this, the WDM transmission apparatus #1 (FIG. 3 etc) receives signal lights of the wavelength λ_{A1}, λ_{A2} and λ_{B1} transmitted thereto from the optical wavelength transmission units 8a to 8c from the respective reception ports 22b and wavelength multiplexes the received signal lights by means of the wavelength multiplexing filter 12.

On the other hand, the WDM transmission apparatus #4 opposing to the WDM transmission apparatus #1 receives the wavelength multiplexed lights from the WDM transmission apparatus #1, and demultiplexes the wavelength multiplexed lights into signal lights of the wavelength λ_{A1}, λ_{A2} and λ_{B1} and transmits the wavelength λ_{A1}, λ_{A2} and λ_{B1} to the optical transmission and reception apparatus 3b, respectively.

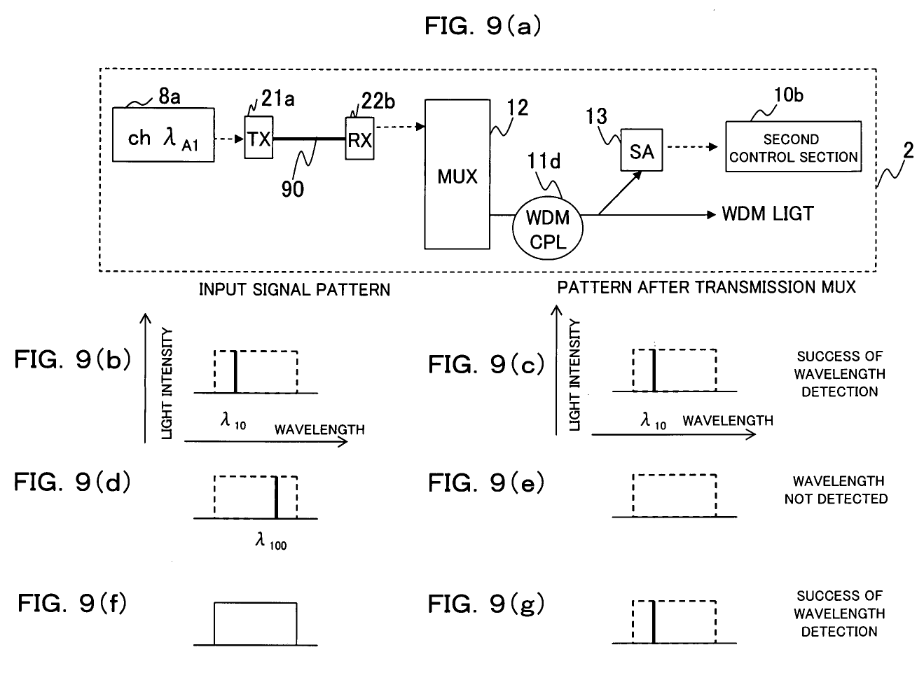

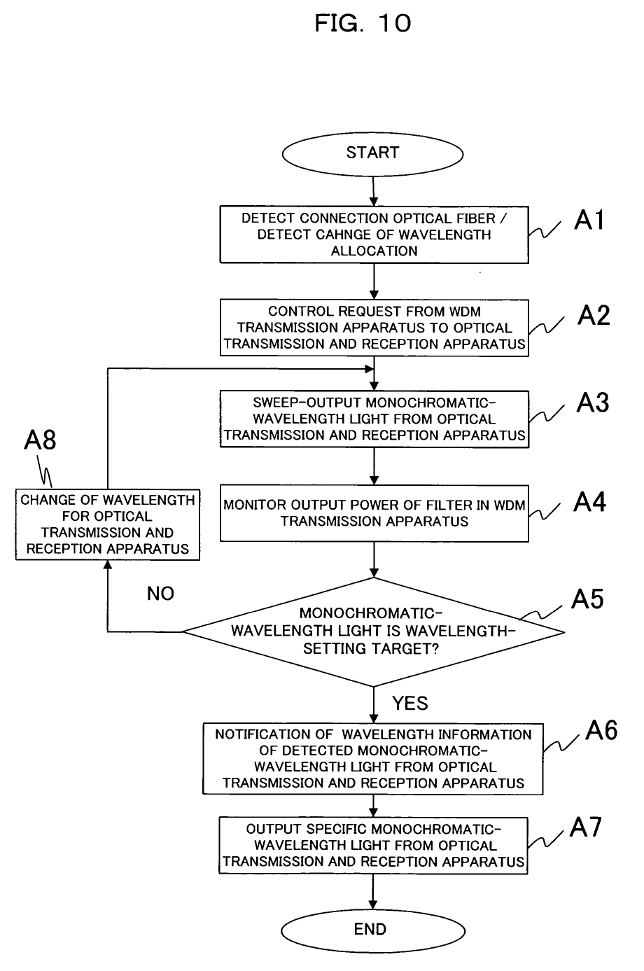

Now, the wavelength allocation section 2 is described with reference to FIG. 8, and next the pass band and transmitting characteristic of the wavelength multiplexing filter 12 with reference to FIGS. 9(a) to 9(g), and an optical wavelength channel connection recognition control method with reference to FIG. 10.

(5) Wavelength Allocation Section (Wavelength Allocation Functional Block or Wavelength Allocation Apparatus) 2

FIG. 8 is a schematic view showing a configuration of a wavelength allocation section 2 according to the first embodiment of the present invention. Referring to FIG. 8, the wavelength allocation section 2 shown is for setting automatically or re-setting automatically collectively each wavelength of signal light of user A, and this function is achieved through a linked operation with the optical transmission and reception apparatus 3a for user A and the WDM transmission apparatus #1. The wavelength allocation section 2 comprises a part (or whole) of the optical transmission and reception apparatus 3a, and the optical fiber 90, and a part (or whole) of the WDM transmission apparatus #1.

Note that a wavelength allocating apparatus represented by a numerous number 4 is described later in an item of a first modification of the first embodiment.

Further, the notification section 34 inside the second reception section 31 is for processing almost same as notification section 33, and comprises a modulator for superposing the control signal to the main signal or laserdiode 26 or other equivalent device etc., a coupler 11a as an optical demultiplexing means, reception ports 22b, a coupler 11a′ (different from the coupler 11a connected to the reception port 22b) for multiplexing light as an optical multiplexing means, connected the modulator or laserdiode 26 etc, an optical attenuator 15 is provided, as occasion demands, between two couplers 11a and 11a′.

Note that each of automatic settings for user A, B is processed independently with each other. The automatic setting for user B is the same as the automatic setting for user A, and redundant description for user B is omitted, unless otherwise specified.

Here, the wavelength allocation section 2 includes, (i) members inside each the optical transmission and reception apparatus 3a such as, a first control section 10a, transmission ports 21a, reception ports 22a, the coupler 11a as an optical demultiplexing means, the photodiode 17 as an optical receiving means for receiving a control signal from the first control section 10a, the optical wavelength transmission units (transmission sections) 8a and 8b as an optical transmitting means being variable of a transmission wavelength, and (ii) members inside the WDM transmission apparatus #1 such as, reception ports 22b, transmission ports 21b, a photodiode 25 as an optical power detecting means, the coupler 11a as an optical demultiplexing means, the coupler 11a′ as an optical multiplexing means, the wavelength multiplexing filter 12 as an optical multiplexing means, a WDM coupler lid as an optical demultiplexing means, the spectrum analyzer 13, the second control section 10b, the modulator or the laser diode 26 for superposing the control signal from the second control section 10b to the main signal.

In the present first embodiment, a control signal light, which is transmitted from the second control section 10b to the optical transmission and reception apparatus 3a, is superposed on the main signal light and transmitted. Note that the optical amplifier 14 as an optical amplifying means and a variable optical attenuator (VAT: Variable Attenuator or VOA: Variable Optical Attenuator) 15 for attenuating a optical power to desired level can be provided, as occasion demands.

Further, the automatic setting represents a setting collectively a plurality of wavelengths of signal light outputted from the optical transmission and reception apparatus 3a for each of user A, B. Note the automatic re-setting is described later in the second embodiment.

With this, a manager would insert (or connect) two optical fibers 90 connected to two ones of the transmission ports (for example, a pair of neighborhood transmission ports) 21a of the optical transmission and reception apparatus 3a into the reception ports 22b, respectively. The WDM transmission apparatus #1, when detects a insertion (or connection) of the optical fiber 90 to reception ports 22b regarding use A, superposes a control request to the main signal light and transmits the superposed main signal light to the optical transmission and reception apparatus 3a.

The photodiode 25 of the WDM transmission apparatus #1 monitors and detects an optical signal power inputted from the reception ports 22b, and notifies the information regarding the power to the second control section 10b. The second control section 10b is notified the detected wavelength from the spectrum analyzer 13, performs a wavelength allocating process, and drive the modulator of the WDM transmission apparatus #1 or the laserdiode 26, and transmits data concerning the detected wavelength information etc, as the control information to the optical transmission and reception apparatus 3a. Then, the optical transmission and reception apparatus 3a, when receives the control information, starts a wavelength setting operation. Further, the optical wavelength transmission unit (transmission sections) 8a and 8b change the wavelength for transmission along an instruction of the first control section 10a.

In this manner, in the present first embodiment, the control information for the wavelength allocation of the wavelength allocation section 2a is performed through transmission and reception of a signal light for each wavelength or in a unit of a wavelength by the first control section 10a and the second control section 10b through the optical fibers 90 for a main signal. Accordingly, a wavelength allocation is carried out by a feedback control based on the detected wavelength information from the WDM transmission apparatus #1 to the optical transmission and reception apparatus 3a. It is to be noted that the linked operation of the optical wavelength transmission unit 8b has a configuration same as that of the optical wavelength transmission unit 8a, and overlapping description of the configuration is omitted.

Further, the wavelength allocation is performed by using common use of the optical transmission and reception apparatus 3a and the WDM transmission apparatus #1. Accordingly, the wavelength allocation function can be realized without repairs inside each apparatus and changes a various setting position etc, and at relatively low cost.

In this way, wavelength allocation section 2a operates as a wavelength allocation function block which realizes the wavelength allocation function.

Now, a wavelength detection method which make use of sweep outputs of the optical wavelength transmission units 8a to 8c and the transmission characteristic of the wavelength multiplexing filter 12 are described in detail with reference to FIGS. 9(a) to 9(g).

FIG. 9(a) is a diagrammatic view showing essential part of the wavelength allocation section 2a according to the first embodiment of the present invention. Note in FIG. 9(a) that the parts with the same reference numerals as described above have the same function. In the following description, wavelength detection in regard to one reception port 22b is described.

First, when an optical fiber 90, connected to the transmission port 21a in the optical wavelength transmission unit 8a, is connected to the reception port 22b in the WDM transmission apparatus #1, the WDM transmission apparatus #1 detects the connection of the optical fiber 90 and transmits the detection to the optical transmission and reception apparatus 3a by detecting a light from the optical transmission and reception apparatus 3a at the photodiode 25. Then, the optical transmission and reception apparatus 3a starts to emit light with a wavelength being set initial wavelength.

Furthermore, if the spectrum analyzer 13 in the WDM transmission apparatus #1 detects an initial wavelength light, the wavelength setting is completed. On the other hand, if the spectrum analyzer 13 does not detect an initial wavelength light, the optical transmission and reception apparatus 3a emits light of another wavelength, and the spectrum analyzer 13 monitors detection or failure in detection again. Thereafter, the optical transmission and reception apparatus 3a successively emits light while shifting the wavelength thereof until after a signal light is detected by the spectrum analyzer 13. In other words, the present optical transmission and reception apparatus 3a outputs each signal light individually. This corresponds to sweep outputting or sweep control of the optical wavelength channel connection recognition control method.

In the following, the sweep control is described in more detail.

FIGS. 9(b) and 9(c) are diagrammatic views individually showing spectrum patterns (spectrum signal patterns) upon success in wavelength detection according to the first embodiment of the present invention. The input spectrum pattern shown in FIG. 9(b) exhibits, for example, only the wavelength λ₁₀ from within the overall wavelength band λ₁ to λ₁₇₆ of the 176 multiplexed lights. Here, if the transmission characteristic of the wavelength multiplexing filter 12 is set to the wavelength λ₁₀, then the spectrum pattern after passage of the wavelength multiplexing filter 12 illustrated in FIG. 9(c) exhibits only the wavelength λ₁₀, and the spectrum analyzer 13 or the second control section 10b discriminates success in wavelength detection. It is to be noted that the axis of abscissa and the axis of ordinate of FIGS. 9(b) to 9(g) indicate the wavelength and the spectrum intensity (spectrum signal intensity), respectively.

FIG. 9(d) and FIG. 9(e) are diagrammatic views individually showing spectrum patterns upon failure in wavelength detection according to the first embodiment of the present invention, and the transmission characteristic of the wavelength multiplexing filter 12 is set to wavelength λ₁₀. If the optical wavelength transmission units 8a to 8c transmit a signal light of, for example, wavelength λ₁₀₀ to reception port 22b for a wavelength λ₁₀ of the WDM transmission apparatus #1, then no spectrum of wavelength λ₁₀₀ appears on the spectrum pattern shown in FIG. 9(e).

In this manner, since the optical wavelength transmission units 8a and 8b sweep and output the wavelengths λ₁ to λ₁₇₆ and the WDM transmission apparatus #1 detects only a signal light of a designated wavelength λₖ (k represents a natural number from 1 to 176), a connection condition of the wavelength by each reception port or channel is detected.

Furthermore, the wavelength multiplexing filter 12 uses a wavelength-variable type filter which can be set to the transmission characteristics of a monochromatic-wavelength light, which causes the wavelength allocation control becomes full automatic. In addition, if an optical fiber 90 is connected, then since optical connection for a channel of an object of setting is established automatically, a plug and play function is implemented. Also, improper connection can be eliminated automatically. Therefore, the necessity for a connection modifying operation which the manager manually sets a wavelength corresponding to the reception port 22b is eliminated, and occurrence of a false connection is prevented, wavelength setting and connection correct/wrong (connection allowance/rejection) discrimination can be performed simultaneously and efficiently.

In the meantime, if the wavelength multiplexing filter 12 uses a filter having a specific wavelength band as a pass band, the manager manually sets the pass band of the wavelength multiplexing filter 12, which enables half automatic.

(6) Optical Wavelength Channel Connection Recognition Control Method of the Present Invention

The present optical wavelength channel connection recognition control method is, as shown in FIG. 8, performed at the wavelength allocation section 2 provided between the optical transmission and reception apparatus 3a and the WDM transmission apparatus #1 (or #4) as an optical transmission apparatus. Here, the optical fibers 90 for communicating with the optical transmission and reception apparatus 3a side of the clients C and D, is connected (or inserted) to each reception port 22b of the WDM transmission apparatus #1, then the WDM transmission apparatus #1 determines an allocation wavelength and issues a notification of the determined wavelength information to the optical transmission and reception apparatus 3a.

More particularly, the WDM transmission apparatus #1 places an optical detector (optical detection section) such as photodiode 17 etc. to the input side of the wavelength multiplexing filter 12. In this state, the optical transmission and reception apparatus 3a sweeps and outputs light emission wavelengths, while at the output side of the wavelength multiplexing filter 12, the wavelength division multiplexed light is monitored. Note that if a band-variable type filter (which is capable of being set to a pass characteristic of a desired monochromatic light from among the plural monochromatic lights) is implemented as the wavelength multiplexing filter 12, the WDM transmission apparatus #1 beforehand sets the transmission characteristic of the band-variable type filter, to a free channel or the like.

Then, if the wavelength of the monochromatic-wavelength light emitted from the optical transmission and reception apparatus 3a is included (or belongs to) a wavelength band in which the light can pass through the wavelength multiplexing filter 12, the signal light is detected by the photodiode 17 of the WDM transmission apparatus #1 and the spectrum analyzer 13. The WDM transmission apparatus #1 issues a notification of the wavelength information (designated wavelength information) obtained by this detection to the optical transmission and reception apparatus 3a, thereby completing the wavelength setting.

On the other hand, if emitted light of the wavelength corresponding to the transmission port 21 to which the optical fiber 90 is connected is not detected, then the WDM transmission apparatus #1 discriminates that the connection of the optical transmission and reception apparatus 3a is invalid with regard to the wavelength.

The processes described as above, the optical wavelength channel connection recognition control method is further described.

FIG. 10 is a flow chart illustrating the optical wavelength channel connection recognition control method according to the first embodiment of the present invention. FIG. 10 shows processes between the WDM transmission apparatus #1 and the optical transmission and reception apparatus 3a, and other processes between apparatuses other than the WDM transmission apparatus #1 and the optical transmission and reception apparatus 3a is similar to the processes as described in FIG. 10.

First, the WDM transmission apparatus #1 detects a connection of the optical fiber 90 for communicating with the optical transmission and reception apparatus 3a (step A1), and transmits a control request to the optical transmission and reception apparatus 3a based on the connection (step A2). Additionally, as an another trigger to transmit this control request, the WDM transmission apparatus #1 detects a change of wavelength allocation in the downstream of the transmission direction side (step A1), and transmits a control request to the optical transmission and reception apparatus 3a based on the change of wavelength allocation (step A2).

It is to be noted that the downstream of the transmission direction represents an apparatus (the other apparatus) in a case that an optical signal is transmitted from one apparatus to other apparatus. That is, the other apparatus means not only the WDM transmission apparatus #1 itself, but also, for example, an optical add/optical drop apparatus (not shown) which is connected to the optical fiber 90 between the optical transmission and reception apparatus 3a and the WDM transmission apparatus #1, and has functions of optical add/optical drop, and still is able to transmit above control request to the WDM transmission apparatus #1 through the optical fiber 90. It means further, an apparatus connected to the optical fiber 90 between the WDM transmission apparatus #1 and the WDM transmission apparatus #4, or an apparatus connected to the optical fiber 90 between the WDM transmission apparatus #4 and the optical transmission and reception apparatus 3b etc.

Next, the optical transmission and reception apparatus 3a individually sweep-outputs the plural monochromatic-wavelength lights (step A3).

In this instance, WDM transmission apparatus #1 monitors the output power (or output waveform) of the wavelength multiplexing filter 12 having a wavelength band including a wavelength band of a desired monochromatic-wavelength light as a pass band (step A4), and by the monitoring discriminates whether the reception light is a target (target of wavelength setting) monochromatic-wavelength light (step A5). At this step A5, if the WDM transmission apparatus #1 detects the monochromatic-wavelength light for wavelength setting, through YES route, at step A6, the WDM transmission apparatus #1 issues a notification of wavelength information of the detected monochromatic-wavelength light (a specific wavelength of a ruled connection port) to the optical transmission and reception apparatus 3a. The optical transmission and reception apparatus 3a outputs the specific monochromatic-wavelength light based on the wavelength information (step A7).

On the other hand, at step A5, if the WDM transmission apparatus #1 does not detect the a monochromatic-wavelength light for wavelength setting, through NO route, at step A8, the optical transmission and reception apparatus 3a changes a wavelength of emission light, and performs processes after step A3.

Here, another processes are described. A variable-band filter is implemented as the wavelength multiplexing filter 12. For example, after step A1, the WDM transmission apparatus #1 adjusts a transmission characteristic of the wavelength multiplexing filter 12, to other transmission characteristic of other wavelength, which is specified to change allocation among each monochromatic-wavelength lights. After the adjustment, the WDM transmission apparatus #1 can start processes from step A2.

In this way, the wavelength allocation is carried out by a link operation of the optical transmission and reception apparatus 3a and the WDM transmission apparatus #1. Moreover, the WDM transmission apparatus #1 detects each connection status of each channel, and by discriminating wavelength setting or connection correct/wrong or connection allowance/rejection based on this detection result, an automatic control is realized for each of a wavelength detection and a wavelength allocation, which eliminates an operation of a connecting the optical fiber 90 by the manager and nonetheless of a use or not-use of a software setting, and not dependent on only an eyes confirming.

(7) Description of Linked Operation of the Wavelength Allocation Section 2a

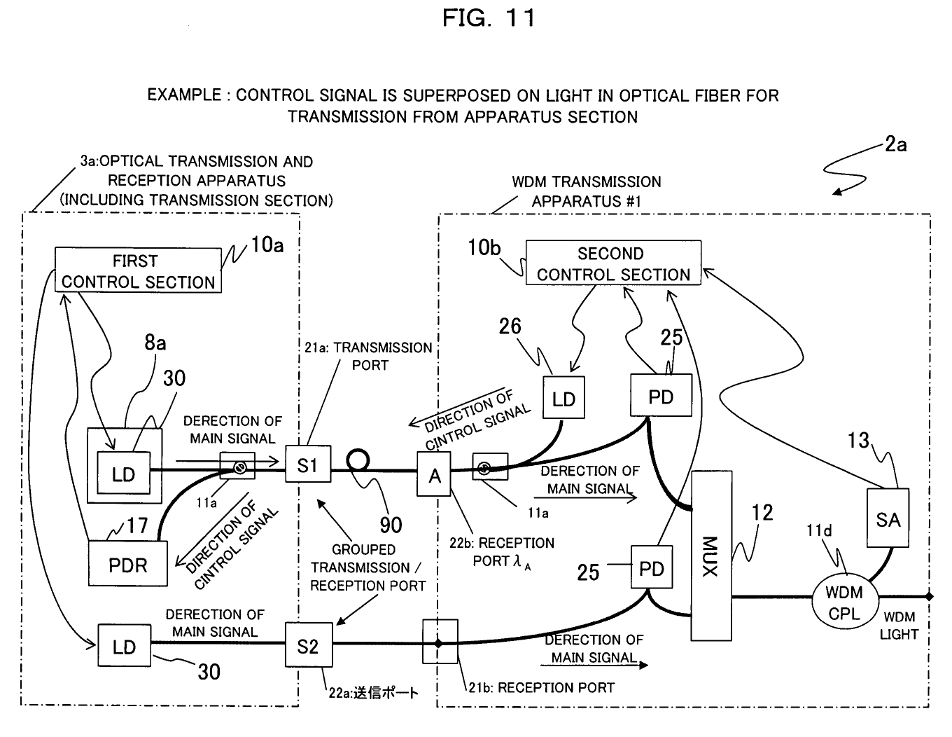

Now, with reference to FIG. 11 to FIG. 13, three kinds of different methods wherein the optical wavelength transmission units 8a to 8c in the wavelength allocation section 2a receive a signal light including wavelength information from the WDM transmission apparatus #1 side are described in detail. It is to be noted that apparatuses and members etc. shown in FIG. 11 to FIG. 13, represented by the same numerous number is the same.

(7-1) Description of First Linked Operation

FIG. 11 is a diagrammatic view for describing an example of the first linked operation according to the first embodiment of the present invention, and the first linked operation is one which a control signal is superposed on a light in the optical fiber 90. Referring to FIG. 11, the wavelength allocation section 2a shown is provided in the WDM transmission system 100 which multiplexes and transmits a plurality of monochromatic-wavelength lights having different wavelengths from one another, and cooperates with the optical transmission and reception apparatus 3a to perform wavelength allocation. The wavelength allocation section 2a as shown in FIG. 11 has a function similar to the function of above-described wavelength allocation section 2, and the description below relates to a case wherein a signal light from a transmission port 21a (denoted by S1) of the optical transmission and reception apparatus 3a, is connected to a reception port 22b (denoted by A) of the WDM transmission apparatus #1.

The control signal outputted by the second control section 10b of the WDM transmission apparatus #1 is superposed on the light of the optical fiber 90 for transmission from the optical wavelength transmission unit (transmission section) 8a, and is notified to the optical transmission and reception apparatus 3a in the reverse direction of the downstream side to the transmission direction side. In short, the notification section 33 notifies the wavelength information of detected monochromatic-wavelength light to the optical transmission and reception apparatus 3a through the optical fiber 90 in which the main signal light is transmitted.

Here, concerning the number for an allocation of a control channel, control line for a control signal is allocated 1 channel, and also a signal line for a main signal is allocated 1 channel. Still, the linked operation works well, if the control line is allocated 1 channel, and the signal line is allocated multi channels.

With foregoing structure, the laserdiode 30 of the optical transmission and reception apparatus 3a emits light, the power of the light is detected by the photodiode 25 of the WDM transmission apparatus #1. After the detection, the modulator or laserdiode 26 in the WDM transmission apparatus #1 is driven (or modulated), to transmit a control request (control signal) including wavelength information from the second control section 10b. The thus driven signal light for controlling (hereinafter referred to as control light) is transmitted to the optical wavelength transmission units 8a to 8c through the optical fiber 90 for a main signal, the optical wavelength transmission units 8a to 8c start wavelength control in response to reception of the control light. The wavelength, signal speed (transmission speed of, for example, optical frames or optical packets), method (for example, an optical transmission/reception protocol) and so forth of the control light in this instance are selected so that the control light may not interfere with the main signal light of the wavelength λₖ. Various wavelengths, signal speeds and so forth can be used within a range within which no such interference occurs.

Consequently, if the control signal is detected by the photodiode 17 in the optical transmission and reception apparatus 3a, the first control section 10a, controls the wavelength of the optical wavelength transmission unit 8a based on the control request. On the other hand, if the wavelength outputted from the optical wavelength transmission unit 8a, as the optical signal processing module, in the WDM transmission apparatus #1 and the wavelength of the signal light having passed through the wavelength multiplexing filter 12 of the WDM transmission apparatus #1 coincide with each other, then the optical power is detected also by the spectrum analyzer 13. The second control section 10b transmits a control signal to the first control section 10a of the optical transmission and reception apparatus 3a based on detection information by the detection.

In this manner, since the control signal is transmitted through an optical fiber 90 for a main signal light, common use of the optical fiber 90 can be achieved.

(7-2) Description of Second Linked Operation

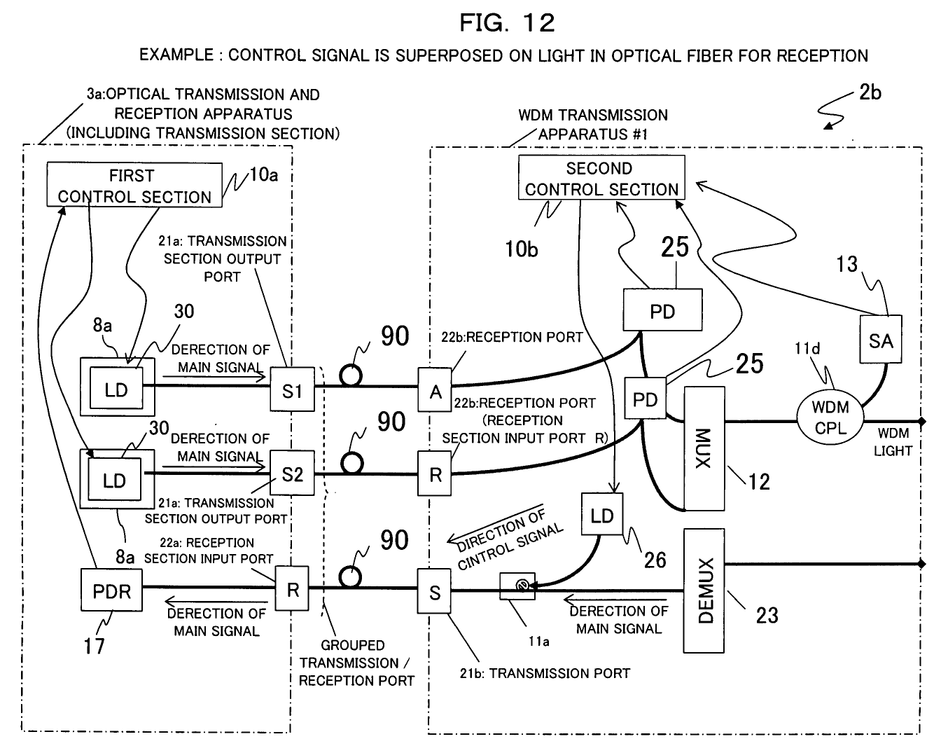

FIG. 12 is a diagrammatic view for describing an example of the second linked operation according to the first embodiment of the present invention, and the second linked operation is one which a control signal is superposed on a light in the optical fiber 90 for reception. The wavelength allocation section 2b as shown in FIG. 12 has a function similar to a function of above the wavelength allocation section 2. The optical transmission and reception apparatus 3a is set (grouping) such that, for example, two transmission ports 21a (hereinafter referred to as ports S1, S2), and one reception port 22a (hereinafter referred to as port R) are in a pair with each other. Consequently, for example, a detection result in the WDM transmission apparatus #1, with regard to the wavelength information outputted from the ports S1, S2 for transmission of the optical transmission and reception apparatus 3a, is received through the port R for reception.

In concrete, for example two optical fibers 90 for a main signal light which is connected to ports S1, S2 in the optical transmission and reception apparatus 3a, is connected to two reception ports 22b (port A and port R denoted by symbols A and R, respectively) in the WDM transmission apparatus #1, and these two port A and port R are connected to the photodiodes (reception sections) 25 corresponding to those two main signal lights in the WDM transmission apparatus #1. Further, transmission port 21b (port S denoted by symbol S) is connected corresponding to port R in the optical transmission and reception apparatus 3a of transmission side. In other words, the signal lights outputted from two ports S1, S2 in the optical transmission and reception apparatus 3a are processed, respectively in reception side (the WDM transmission apparatus #1). The WDM transmission apparatus #1 transmits signal light including this processed result through the port S, and the port R in the optical transmission and reception apparatus 3a receives this signal light. Accordingly, the setting is done such that ports S1, S2 for transmission and port R for reception are in a pair.

This way, the notification section 33 notifies the wavelength information of detected monochromatic-wavelength light to the optical transmission and reception apparatus 3a through the reception port 21b in the WDM transmission apparatus #1 corresponding to each transmission port 22b in the WDM transmission apparatus #1.

Here, concerning the allocated number of the optical fiber 90, control line for a control signal is allocated 1 channel, and a signal line for a main signal is allocated 2 channels. Still, the linked operation works well similar to above, if the control line is allocated 1 channel, and the signal line is allocated 1 channel, or if the control line is allocated 1 channel, and the signal line is allocated multi channels.

With foregoing structure, the optical wavelength transmission unit 8a of the optical transmission and reception apparatus 3a emits light, the power of the light is detected by the photodiode 25 of the WDM transmission apparatus #1, and the second control section 10b outputs a control request to the optical wavelength transmission unit 8a. The modulator or laserdiode 26 is driven or modulated with the control signal including this control request, and thus driven or modulated main signal light is transmitted to the port R in the optical transmission and reception apparatus 3a through the existing optical fiber 90 for a main signal light. Accordingly, the control signal is superposed on received main light, and thus transmitted back.

Further, since the WDM transmission apparatus #1 transmits the control light (control signal light) in the same direction as one of the main signal light, a scheme to perform a modulation to the main signal itself (within a range in which the main signal is not influenced upon), can be used. Furthermore, in this transmission-back, wavelength, signal speed or method and so forth of the control light can use various wavelengths, signal speeds or modulation schemes and so forth within a range within which no interfere with the main signal light of the wavelength λₖ.

In the meanwhile, the optical transmission and reception apparatus 3a controls wavelengths based on the received control information.

Then, the first control section 10a, controls the wavelength of the optical wavelength transmission unit 8a based on the received control request. On the other hand, coincidence or in-coincidence between the signal light wavelengths is detected in the WDM transmission apparatus #1, and the second control section 10b transmits a control signal to the first control section 10a, of the optical transmission and reception apparatus 3a based on detection information by the detection.

Since a control signal is transmitted from the WDM transmission apparatus #1 to the optical transmission and reception apparatus 3a using a reception port 22b provided in opposite to a transmission port 21a in the optical transmission and reception apparatus 3a, in this manner, the control can be performed simply.

Further, transmission port 21b in the WDM transmission apparatus #1, and port R, photodiode 17 in the optical transmission and reception apparatus 3a can use the one of the existing the WDM transmission apparatus #1 and the optical transmission and reception apparatus 3a, in this way, reduction in cost for newly development etc. is achieved. In short, the existing processing module for signal light can be available.

(7-3) Description of Third Linked Operation

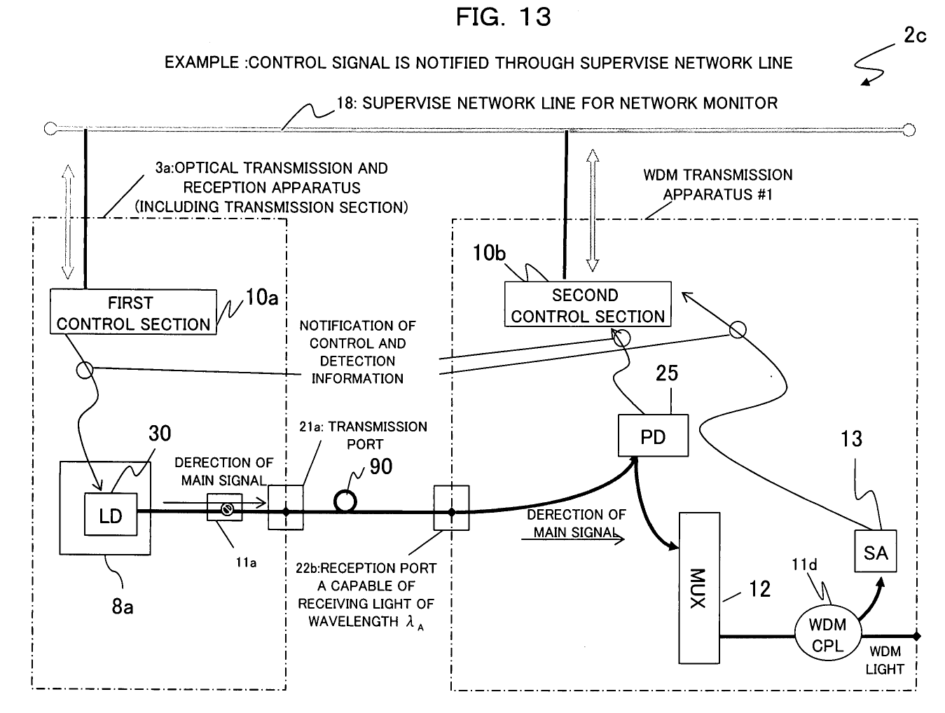

FIG. 13 is a diagrammatic view for describing an example of the third linked operation according to the first embodiment of the present invention, and the third linked operation is one which a control signal is notified through a supervise network line (a communication circuit for monitoring a network or an electric communication circuit for a supervise etc.) 18.

The wavelength allocation section 2c as shown this FIG. 13 has a function similar to the function of above-described wavelength allocation section 2, and a signal light from the transmission port 21a in the optical transmission and reception apparatus 3a is transmitted to the reception port 22b in the WDM transmission apparatus #1.

Further, the supervise network line 18 is a circuit provided for normally supervising or maintaining an apparatus and a system through an IP network for which, for example, the TCP/IP (Transmission Control Protocol/Internet Protocol) protocol is applied for. Note that a function of the supervise network line 18 can be also achieved by an outside line which is essentially consist of the optical fiber 90 connecting between the optical transmission and reception apparatus 3a, 3b and the WDM transmission apparatus #1-#6. With this, monitoring information with regard to a network, an apparatus and a system can be notified destinated to various communication apparatuses belonging to the optical transmission system 200 inside a whole network.

Consequently, the notification section 33 notifies the optical transmission and reception apparatus 3a of detected wavelength information of a monochromatic-wavelength light through the supervise network line 18 provided, for example, for an IP network for supervising the IP network.

Note that an IP network or various networks N1-N6 as shown in FIG. 2 can serve as the supervise network line 18.

With foregoing structure, when the laserdiode 30 of the optical transmission and reception apparatus 3a emits light, the power of the light is detected by the photodiode 25 of the WDM transmission apparatus #1. After the detection, the WDM transmission apparatus #1 transmits control information to the optical transmission and reception apparatus 3a, and the first control section 10a starts wavelength control.

Further, when the signal light is detected by the photodiode 25 of the WDM transmission apparatus #1, the second control section 10b transmits a control request to the optical transmission and reception apparatus 3a through the supervise network line 18. Based on the control request received from the WDM transmission apparatus #1, the first control section 10a of the optical transmission and reception apparatus 3a, controls the wavelength of the laserdiode 30.

Further, the spectrum analyzer of the WDM transmission apparatus #1 performs detection of coincidence, and based on the detection information, the second control section 10b of the WDM transmission apparatus #1 transmits a control signal to the first control section 10a, of the optical transmission and reception apparatus 3a through the supervise network line 18.

Since a control signal is transmitted using the supervise network line 18 in this manner, for example, if a fault occurs with the optical fiber 90 for a main signal, then a transmission line for a control signal is assured, and the reliability of the WDM transmission system 100 is maintained.

Furthermore, the third linked operation as shown FIG. 13, can perform together with each linked operation as shown FIGS. 11 and 12, also can work in bi-directional transmission. Still more, wavelength setting and wavelength selection can be automatically detected and automatically set efficiently in response to a connection condition of the optical fiber 90, and consequently, the convenience in channel allocation is improved significantly.

(8) Description of the Optical Wavelength Channel Connection Recognition Control Method Using Sweep Control

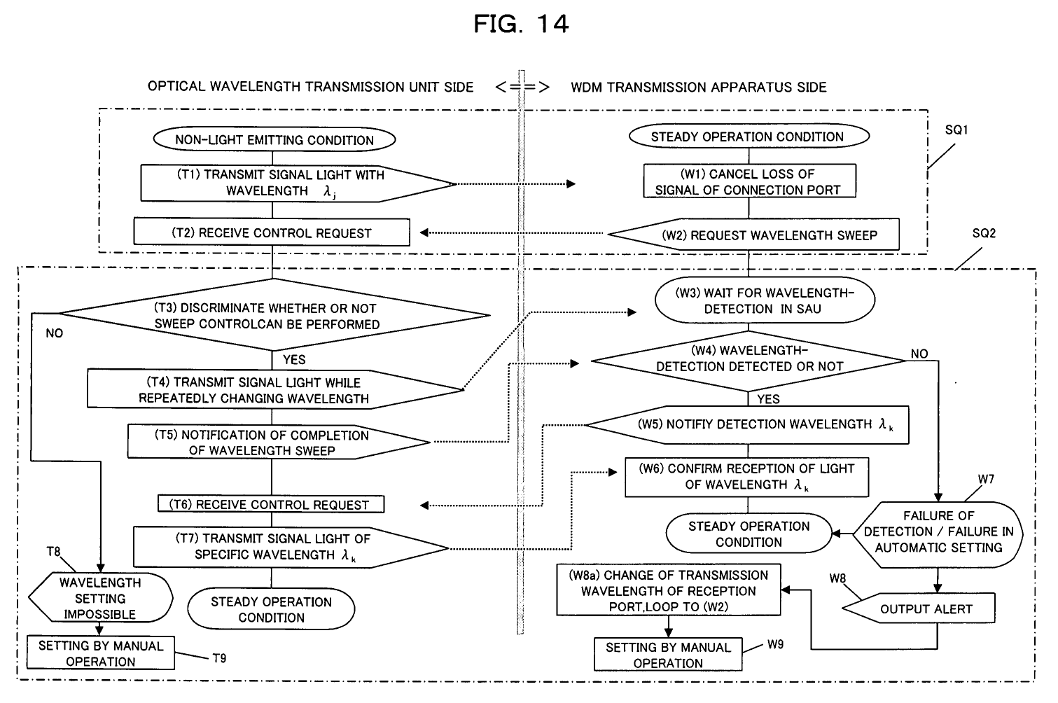

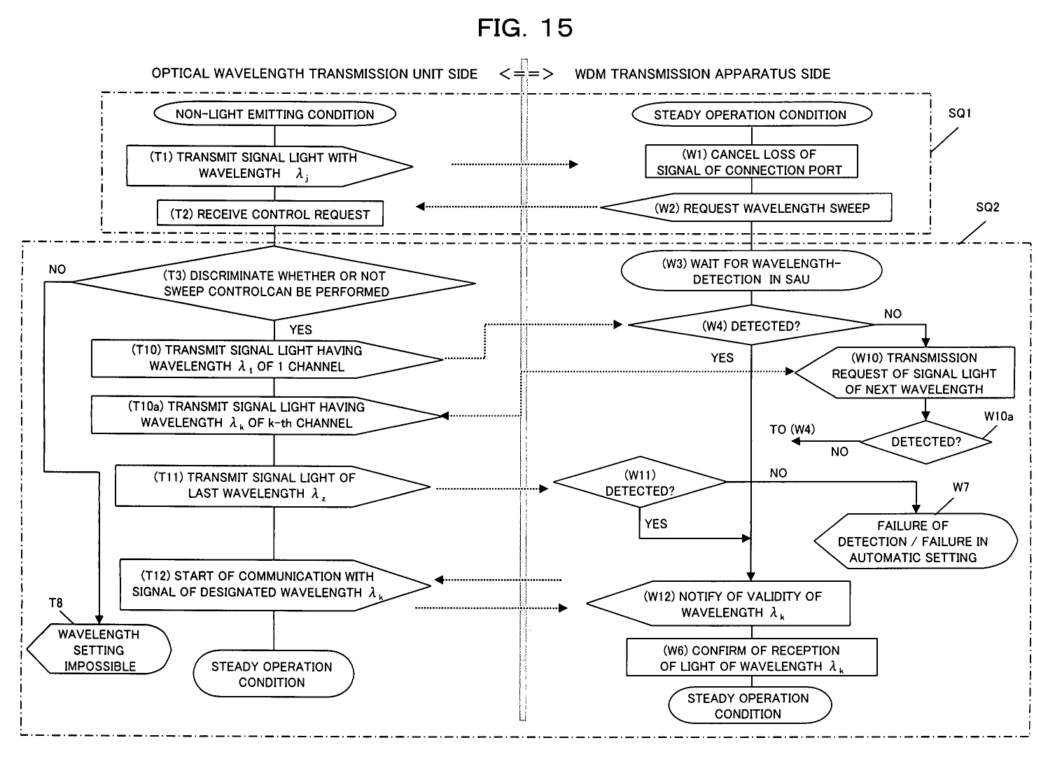

Further, an optical wavelength channel connection recognition control method which uses sweep control is described in detail with reference to FIGS. 14 and 15.

(8-1) Sweep Control Method for Sweeping the Overall Region Wherein Wavelength Control is Possible

FIG. 14 is a flow chart illustrating a method of sweep control for the overall region wherein wavelength control is possible according to the first embodiment of the present invention. The method is executed between the optical wavelength transmission units 8a to 8c and the WDM transmission apparatus #1.

Here, the optical wavelength transmission units 8a to 8c in a non-light emitting condition first transmit optical signals of an arbitrary wavelength λⱼ (j represents a natural number) to the WDM transmission apparatus 1 (WDM transmission apparatus #k) in order to confirm connection conditions of optical fibers 90 between the optical wavelength transmission units 8a to 8c and the WDM transmission apparatus 1 (step T1). Meanwhile, the WDM transmission apparatus 1 side normally monitors the input from the reception port 22b by the photodiode 17 provided in the stage preceding to the wavelength multiplexing filter 12 with regard to the reception ports for all channels, and if light power of the desired designated wavelength λₖ is detected, then the WDM transmission apparatus 1 confirms cancellation of a state wherein no signal light is present (Loss of Light or Loss of Signal) (step W1). Then, the WDM transmission apparatus 1 transmits a wavelength sweep request (or control request) to the optical wavelength transmission units 8a to 8c (step W2). The optical wavelength transmission units 8a to 8c receive the wavelength sweep request (step T2) and perform control of wavelength allocation. It is to be noted that a block denoted by reference character SQ1 represents a sequence common to other sweep control methods hereinafter described.

Receiving wavelength sweep request, the optical wavelength transmission units 8a to 8c discriminate whether or not the sweep control can be performed (step T3). If the sweep control cannot be performed, then the optical wavelength transmission units 8a to 8c determine that the wavelength setting is impossible (step T8). In this instance, if the wavelength multiplexing filter 12 is a filter (the first mode) which has a wavelength band including a wavelength band of a desired monochromatic-wavelength light as a pass band, then each optical wavelength transmission units 8a to 8c alerts a message that wavelength setting automatically is impossible to the manager, and wavelength setting is performed by manual operation of the manager (step T9).

Meanwhile, if the wavelength multiplexing filter 12 is a filter (the second mode) which is capable of being set to a pass characteristic of a desired monochromatic-wavelength light, then the second control section 10b changes a transmission wavelength of the reception port 22b (it means the second control section 10b adjusts a characteristic of the wavelength multiplexing filter 12) (step W8a), and processed from step W2 are performed.

Next, at step T3, the optical wavelength transmission units 8a and 8b discriminate that the sweep control is possible, then the processing passes the YES route, and the optical wavelength transmission units 8a and 8b start the sweep control and transmit a signal light to the WDM transmission apparatus #1 while repeatedly successively changing the wavelength (step T4). The spectrum analyzer 13 of the WDM transmission apparatus #1 enters a detection operation for signal lights of the wavelengths corresponding to the reception ports (step W3). Or if normal monitoring in the spectrum analyzer 13 is performed, the WDM transmission apparatus #1 goes on waiting a new wavelength detection (step W3).

When the wavelength sweep outputting is completed, the optical wavelength transmission units 8a and 8b issue a notification of the completion to the WDM transmission apparatus #1 (step T5). In response to reception of the notification, the WDM transmission apparatus #1 discriminates whether or not a signal light is detected with regard to any of the wavelengths (step W4). If a signal light is detected, then the processing passes the YES route, and the WDM transmission apparatus #1 issues a notification of information of the wavelength of the detected signal light (for example, the detection wavelength λ₁) as a control request to the optical wavelength transmission units 8a and 8b side (step W5). When the optical wavelength transmission units 8a and 8b receive the control request (step T6), they start transmission of a signal light of the designated wavelength λₖ (step T7). The WDM transmission apparatus #1 confirms reception of the signal light of the designated wavelength λₖ (step W6) and enters a steady operation condition.

On the other hand, if the optical wavelength transmission units 8a and 8b cannot perform wavelength sweep control or the spectrum analyzer 13 cannot detect any wavelength at step W4, then the processing passes the NO route, and the WDM transmission apparatus #1 determines failure in detection or failure in automatic setting (step W7), and outputs an alert (step W8). In this instance, transmission wavelength is changed (step W8a), if a re-setting after the change fails, manual wavelength setting is performed (step W9).

It is to be noted that a block denoted by reference character SQ2 represents a sequence common to that of other sweep control methods hereinafter described.

In this manner, the optical wavelength transmission units 8a and the WDM transmission apparatus #1 cooperate with each other, and wavelength setting is completed by sweep control for an overall region wherein wavelength control is possible.

(8-2) Sweep Control Method Wherein Confirmation Together With the WDM Transmission Apparatus #1 is Confirmed After Every Wavelength Change

Now, a method wherein the optical wavelength transmission units 8a and 8b confirm together with the WDM transmission apparatus #1 every time the optical wavelength transmission units 8a and 8b change a wavelength by shifting the wavelength using the sweep control is described in detail with reference to FIG. 15.

FIG. 15 is a flow chart illustrating a method of sweep control performed every time a wavelength changes according to the first embodiment of the present invention. Namely, every time a wavelength changes, the transmission and reception sides confirm the change and perform the sweep control.

Here, in a portion denoted by SQ1 processes substantially same as those in the sequence S1 illustrated in FIG. 14 are performed. The optical wavelength transmission units 8a and 8b discriminate whether or not control is possible at step T3, and if it is discriminated that wavelength setting is impossible, then the optical wavelength transmission units 8a, 8b performs in accordance with a kind of the wavelength multiplexing filter 12 as described below. That means if the wavelength multiplexing filter 12 is a filter which has a wavelength band including a wavelength band of a desired monochromatic-wavelength light as a pass band, then each optical wavelength transmission units 8a, 8b alerts a message that the automatic wavelength setting is impossible to the manager, and the manager manually operates a wavelength setting. Meanwhile the wavelength multiplexing filter 12 is a filter which is capable of being set to a pass characteristic, the second control section 10b changes the transmission wavelength of the reception port 22b, and perform processes from step W2.

On the other hand, if then control is possible at step T3, then the processing passes the YES route, and the optical wavelength transmission units 8a and 8b set the wavelength in the ascending order or in an order of some other priority degree and transmits a signal light of, for example, the wavelength λ₁ of the channel 1 (step T10). The spectrum analyzer 13 of the WDM transmission apparatus #1 monitors detection or no-detection of a signal light of the designated wavelength λₖ (step W4). If the designated wavelength λₖ is detected, the processing passes the YES route, then the spectrum analyzer 13 sends to the optical wavelength transmission units 8a and 8b side a message that the wavelength λₖ is valid (step W12). In response to reception of the notification, the optical wavelength transmission units 8a and 8b start communication by emission of a light of the designated wavelength λₖ (step T12).

Further, at step W4, the WDM transmission apparatus #1 does not detect a specific wavelength λₖ, the processing passes the NO route. At step W10, the WDM transmission apparatus #1 transmits a transmission request of the signal light of the next wavelength (for example, wavelength λ₂) to the optical wavelength transmission units 8a, 8b as well as monitoring existence or not of a detection of the signal light having wavelength λ₂.

On the other hand, when the optical wavelength transmission units 8a and 8b cannot perform wavelength sweep control or the WDM transmission apparatus #1 receives a signal light of the last wavelength from among the wavelengths of all channels which the optical wavelength transmission units 8a, 8b can transmit, the setting is in failure.

Further, at step T10a, the optical transmission and reception apparatus 3a transmits a k-th channel signal light having wavelength λₖ, and continue this transmission. In this instance, the WDM transmission apparatus #1 continues to monitor a signal light having wavelength λₖ, with a loop W4. When the WDM transmission apparatus #1 receives a signal light having wavelength λₖ, processing passes the YES route, and through the loop W4, notifies a message that the signal of wavelength λₖ is validly received to the optical transmission and reception apparatus 3a (step W12).

Moreover, after step W10, if both sides completes a sweep of all wavelength to be supported, at step W11, the WDM transmission apparatus #1 discriminates whether a desired wavelength is detected or not. The processing before passing to this step W11, at step W10a, a processing for demultiplexing similar to a process at step W4 is performed.

Then, if the optical wavelength transmission units 8a and 8b transmit a signal light of the last wavelength λ_{z} (step T11: z denotes natural number corresponding to each wavelength), the WDM transmission apparatus #1 receives the signal light of the last wavelength λ_{z} (step W4), then the processing passes the YES route, and the WDM transmission apparatus #1 notifies the optical wavelength transmission units 8a and 8b that a particular wavelength, for example, the wavelength λₖ, is valid (step W12). The optical wavelength transmission units 8a to 8c use a signal light of the wavelength λₖ to start communication (step T12). The WDM transmission apparatus #1 confirms reception of the signal light of the wavelength λₖ (step W6) and then enters a steady operation condition. It is to be noted that, if the WDM transmission apparatus #1 does not detect a signal light of any of the wavelengths λₖ at step W11, then the processing passes the NO route, and the WDM transmission apparatus #1 determines “failure in detection or failure in automatic detection” (step W7).

In addition to that, at step W11, the detected wavelength is determined whether the detected wavelength is the last swept wavelength or not. The optical wavelength transmission unit (transmission section) 8a, 8b, when switches a wavelength, makes off a power output of a light having wavelength λₙ (n denotes natural number), and outputs a newly post-switched light having wavelength λₙ₊₁. With this switching process, both optical wavelength transmission units (transmission section) 8a, 8b can use a method of counting the number of switching in the WDM transmission apparatus #1 side, and a method of an ending by repeating a request for times regarding the number of maximum supporting wavelength after a signal transmitting request in every wavelength, by starting a timer after ending of signal transmission request of each wavelength.

As above, the present optical transmission system 200 includes (i) the optical transmission and reception apparatus (a first optical transmission apparatus) 3a for outputting, for example, each monochromatic-wavelength lights having wavelengths different from each other and (ii) the WDM transmission apparatus #1 (a second optical transmission apparatus) for multiplexing the each of monochromatic-wavelength lights outputted from the optical transmission and reception apparatus 3a and transmitting the wavelength division multiplexed lights.

Here, the optical transmission and reception apparatus 3a includes the optical wavelength transmission unit (the transmission section) 8a to 8c for outputting the each of monochromatic-wavelength lights individually, and the photodiode (the first reception section) 17 for receiving a notification including wavelength information of monochromatic-wavelength lights allocated in the WDM transmission apparatus #1 (allocated in the downstream of the transmission direction side) from among the plural monochromatic-wavelength lights from the WDM transmission apparatus #1 (from the downstream of transmission direction side), and the first control section 10a, for controlling wavelengths of the monochromatic-wavelength lights to be outputted from the optical wavelength transmission unit (the transmission section) 8a to 8c based on the wavelength information of the monochromatic-wavelength lights received by the photodiode 17.

Other side, the WDM transmission apparatus #1 (the second optical transmission apparatus) includes the second reception section 31 for receiving the monochromatic-wavelength lights individually outputted from the optical transmission and reception apparatus (the first optical transmission apparatus) 3a, the allocation section (the third allocation section) for allocating a wavelength of a monochromatic-wavelength light based on a power of the monochromatic-wavelength light received by the second reception section 31 from among the each of monochromatic-wavelength lights, and the notification section 33 for issuing a notification of wavelength information of the monochromatic-wavelength lights allocated by the allocation section 33 to the optical transmission and reception apparatus (the first optical transmission apparatus) 3a.

In this manner, the optical wavelength transmission units (transmission sections) 8a, 8b cooperate with the WDM transmission apparatus #1 to confirm, every time the wavelength is changed by wavelength shifting, the change with the WDM transmission apparatus #1 to perform sweep control, reliable wavelength setting can be achieved.

(9) Description of Modifications

(9-1) First Modification

Referring to above, for example, FIG. 8, the functions for transmission of the a monochromatic-wavelength lights, control and so forth are provided in the optical transmission and reception apparatus 3a while the functions for wavelength allocation, notification and so forth are provided in the WDM transmission apparatus #1, and these functions are provided scatteringly. Accordingly, the functions mentioned can be provided separately from the optical transmission and reception apparatus 3a and the WDM transmission apparatus #1.

Concretely, a modified configuration is realized by eliminating each port (such as the transmission port 21a, the reception port 22a both provided in the optical transmission, and the reception ports 22b, 21b both provided in the WDM transmission apparatus #1) and the optical fiber 90 connected to these ports, respectively, and concentrating above each function.

Then, the optical transmission system 200 changes inner configurations both of the optical transmission and reception apparatus 3a and the WDM transmission apparatus #1, furthermore, integrates a part of elements or whole of elements of the optical transmission and reception apparatus 3a, also a part/whole of elements of the WDM transmission apparatus #1, and thereby build a single wavelength allocation apparatus 4 (see FIG. 8).

The present wavelength allocation apparatus 4 is provided in the optical transmission system 200 and has a function of multiplexing and transmitting, for example, 176 monochromatic-wavelength lights having wavelengths different from each other, and this function is the same as one of the wavelength allocation section 2.

In other words, the present wavelength allocation apparatus 4 includes a the optical wavelength transmission unit (transmission section) 8a, 8b for outputting each of monochromatic-wavelength lights individually, and the allocation section (the first allocation section) 32 for allocating a wavelength of a monochromatic-wavelength light based on a power of the monochromatic-wavelength light individually outputted from the transmission section from among the plural monochromatic-wavelength lights, and the notification section 33 for issuing a notification of wavelength information of the monochromatic-wavelength lights allocated by the allocation section 32 to the optical wavelength transmission unit (transmission section) 8a, 8b, and the first control section 10a for controlling wavelengths of the monochromatic-wavelength lights to be outputted from the optical wavelength transmission unit (transmission section) 8a, 8b, based on the wavelength information of the notification issued from the notification section 33.

Since the WDM transmission apparatus #4 is provided with a part (or whole) of the optical transmission and reception apparatus 3a, and a part (or whole) of the WDM transmission apparatus #1, the present wavelength allocation apparatus 4 is given the same function as one of the wavelength allocation section 2. This way, the present wavelength allocation apparatus 4 can be configured as an apparatus which is provided in the optical transmission system 200 for multiplexing and transmitting each of monochromatic-wavelength lights having wavelengths different from each other.

According to the configuration described above, it is also possible to form a module having the wavelength automatic allocation function and so forth as a product of a single device.

(9-2) Second Modification

Where each of monochromatic-wavelength lights are outputted individually, the optical wavelength transmission unit (transmission section) 8a can use various orders in sweeping of wavelengths. As examples, (i) in place of sweeping for every one channel, the optical wavelength transmission unit (transmission section) 8a sweeps each monochromatic-wavelength light in order at desired number of ports and wavelength shift intervals such that the optical wavelength transmission unit (transmission section) 8a sweeps each single channel discretely for each 10 channels (for example), and is allowed to control 10 ports simultaneously etc. (ii) When the optical wavelength transmission unit (transmission section) 8a changes channels in service without adding more wavelengths, the optical wavelength transmission unit (transmission section) 8a monitors each of traffic amounts of the signal lights, and changes (sweep-controls) channels in an ascending order of the traffic amount. Accordingly, the sweep in the WDM transmission system 100 can be performed in a desired orders.

In addition, also it is possible for the optical transmission and reception apparatus 3a to output all monochromatic-wavelength lights or each of monochromatic-wavelength lights at a time in place of outputting each of monochromatic-wavelength lights individually.

FIGS. 9(f) and 9(g) are diagrammatic views individually illustrating spectrum patterns upon success of wavelength detection according to the second modification to the first embodiment of the present invention.

The optical wavelength transmission units (transmission sections) 8a to 8c is capable of outputting white light including the individual wavelength bands of the each of monochromatic-wavelength lights, and the spectrum analyzer 13 detects the power of a monochromatic-wavelength light which coincides with a pass band (for example, λ₁₀) of the wavelength multiplexing filter 12 from among each of monochromatic-wavelength lights included in the white light outputted from the optical wavelength transmission units 8a and 8b.

Thus, when the white light illustrated in FIG. 9(f) (light having spectrum components in the overall band of the 176, corresponding to the number of wavelengths, multiplexed lights or a band in a fixed range) is inputted to the single reception port 21b shown in FIG. 9(a), then the spectrum pattern detected at the detection position of the spectrum analyzer 13 or the like exhibits appearance, for example, only of the wavelength λ₁₀ corresponding to the reception port 21b as seen in FIG. 9(g). Then, the spectrum analyzer 13 or the second control section 10b determines success in wavelength detection and ends the wavelength setting regarding the wavelength λ₁₀. Thereafter, the wavelength multiplexing filter 12 changes the transmission characteristic to the wavelength λ₁₁, and performs and ends wavelength detection regarding the wavelength λ₁₁. A wavelength setting is repeated similarly also with regard to the succeeding wavelengths until setting of all of the wavelengths is completed.

By the process described above, automatic setting of a plurality of wavelengths can be performed at a time. In this instance, since the necessity for the cooperation between the optical transmission and reception apparatus 3a and the WDM transmission apparatus #1 is eliminated, rapid and efficient wavelength setting can be achieved.

Further, also where the optical wavelength transmission units 8a and 8b side emit white light within a wavelength range within a sweep range in this manner, the wavelength setting function can be implemented.

(9-3) Third Modification

Also it is possible to provide, to the optical transmission and reception apparatuses 3a, 3b and the WDM transmission apparatus #1, both of the wavelength setting function by sweeping and the wavelength setting function wherein white light is used and switchably use the functions to perform wavelength setting.

In the optical transmission system 200 of the third modification, the optical wavelength transmission units (transmission sections) 8a, 8b both can output (i) each of monochromatic-wavelength lights or (ii) white light including the individual wavelength bands of the each of monochromatic-wavelength lights.

That is to say, the optical wavelength transmission units (transmission sections) 8a, 8b output (i) a single light or (ii) a white light having 176 wavelength-bands.

Moreover a second allocation section is provided in the WDM transmission apparatus #1 side. This second allocation section is for allocating each channel of each a monochromatic-wavelength light based on (a) a power of the a monochromatic-wavelength light outputted individually from the optical wavelength transmission units (transmission sections) 8a to 8c among each of a monochromatic-wavelength light, or (b) a power of white light

In this instance, the optical transmission system 200 includes optical wavelength transmission units 8a and 8b for outputting 176 monochromatic-wavelength lights or white light including individual wavelength bands of the 176 monochromatic-wavelength lights, a second allocation section for allocating a channel of each monochromatic-wavelength light based on the power of a monochromatic-wavelength light individually outputted from the optical wavelength transmission units 8a to 8c from among the 176 monochromatic-wavelength lights or a power of the white light, a notification section for issuing a notification of wavelength information of the monochromatic-wavelength lights allocated by the allocation section to the optical wavelength transmission units 8a to 8c, and a first control section 10a for controlling the monochromatic-wavelength lights to be outputted from the optical wavelength transmission units 8a to 8c based on the wavelength information of the notification issued from the notification section. This makes wavelength setting further efficient.

In this instance, when the WDM transmission apparatus #1 processes wavelength setting using white light, the WDM transmission apparatus #1 notifies information including a discrimination label etc. which can specify a real value of a detected wavelength or a wavelength (a wavelength channel), to the optical transmission and reception apparatus 3a of a transmission side to set the wavelength.

In the meanwhile, when the optical wavelength transmission unit (transmission section) 8a (or 8b) sweep-outputs each monochromatic-wavelength light individually, instead of notifying information including a real value of a detected wavelength or the discrimination label closely, an instance which the WDM transmission apparatus #1 side detects a wavelength, the WDM transmission apparatus #1 sends a notification having a message “detected the wavelength now transmitted” to the optical wavelength transmission unit (transmission section) 8a.

In this way, the wavelength detection information is notified at a timing detected the wavelength, a relatively easy wavelength setting can be carried out.

(9-4) Fourth Modification

Also it is possible to use a wavelength for exclusive use for control in order to control the linked operation.

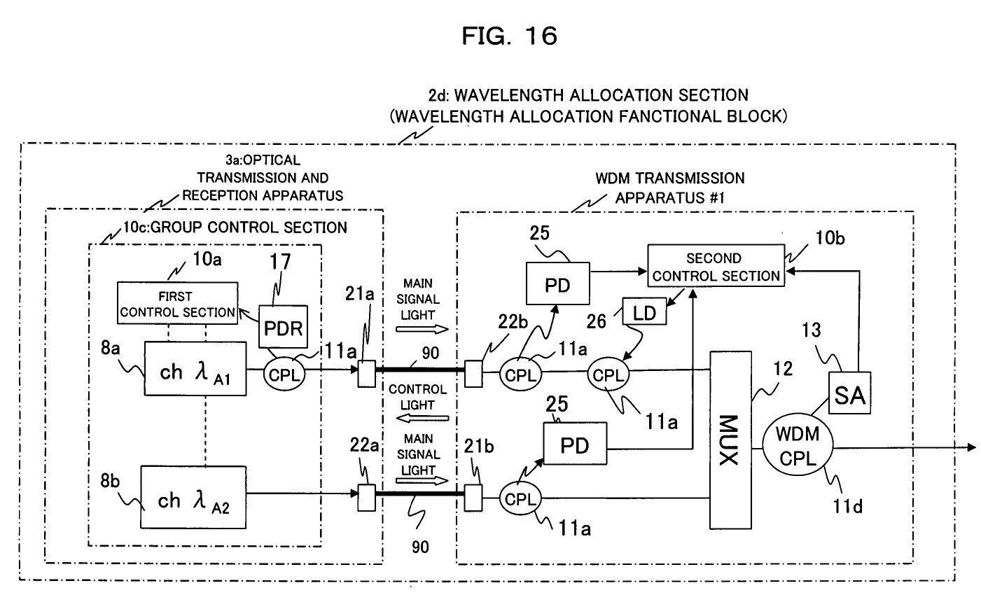

FIG. 16 is a diagrammatic view showing a configuration of the wavelength allocation section according to a fourth modification of the first embodiment of the present invention. Referring to FIG. 16, the wavelength allocation section 2d shown is different from the wavelength allocation section 2a shown in FIG. 9(a) in that it uses one wavelength as a control channel to control the other wavelengths in a unit of a group.

A group control section (Group Cnt) 10 c groups a plurality of channels which make an object of wavelength setting and performs wavelength setting of the group. The group control section 10c is an integrated block of the first control section 10a and the optical wavelength transmission units 8a and 8b described hereinabove. The group control section 10c represents a wavelength group (unit of a group) which makes an object of wavelength setting or wavelength control.

If the exclusive channel for control is allocated, similar to a system without setting exclusive channel (refer to e.g. FIG. 11), the control signal can be superposed on main light. Elements provided in the optical transmission system 200a shown in FIG. 16 have transmission and reception functions similarly as in those of the apparatus shown.

Consequently, the power of each of monochromatic-wavelength lights (single-wave signals) from the optical wavelength transmission units 8a and 8b is detected by photodiode 25 in the WDM transmission apparatus #1, and this is detected by the spectrum analyzer 13.

After the detection, the second control section 10b of the WDM transmission apparatus #1 transmits a control signal including the detected wavelength information to the optical wavelength transmission units 8a to 8c of the optical transmission and reception apparatus 3a. The control signal has a band corresponding to the one wavelength for control from among main signal lights and is superposed on signal lights transmitted on the transmission direction side in an optical fiber 90 and transmitted in the reverse direction to the transmission direction (that is, in the direction from the WDM transmission apparatus #1 to the optical transmission and reception apparatus 3a). Each of the optical wavelength transmission units 8a to 8c demodulates the control signal transmitted in the reverse direction to extract wavelength information, and sets the wavelength of the signal light to be outputted from the optical wavelength transmission units 8a and 8b based on the extracted wavelength information thereby to control the wavelength of the signal light.

In this manner, the optical on every wavelength is not performed, allocation control becomes efficient. Further, the allocation control is performed on each group, a load for control become reduced.

(9-5) Fifth Modification

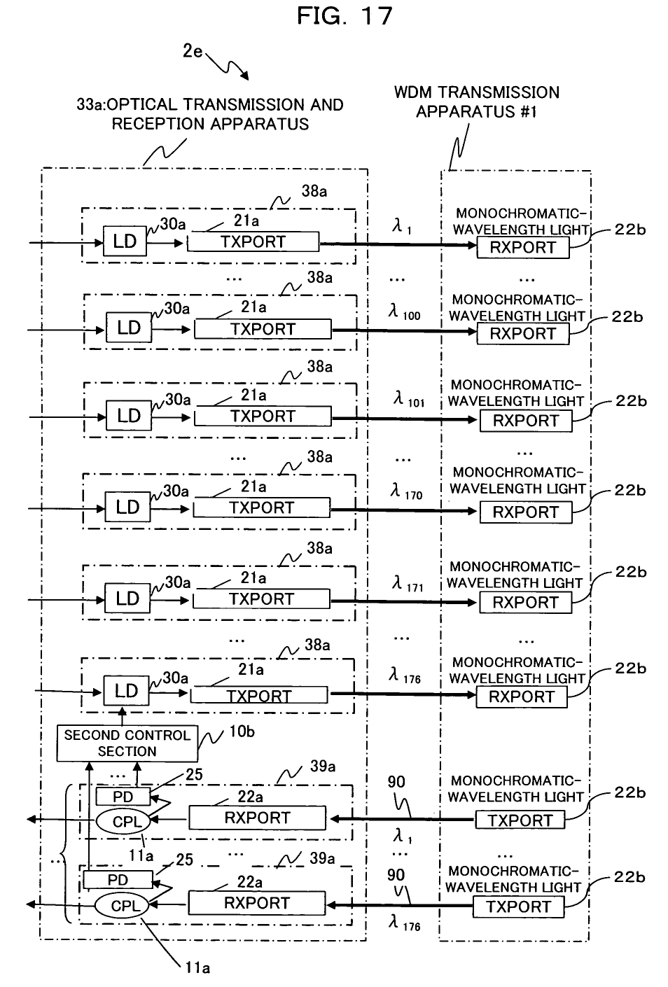

FIG. 17 is an outline of a schematic block diagram showing an optical transmission and reception apparatus according to the fifth modification of the first embodiment of the present invention. In an optical transmission and reception apparatus 33a shown in FIG. 17, an optical wavelength transmission unit 38a, which includes a laser diode 30a for outputting a monochromatic-wavelength light and transmission ports 21a, are provided, and the number of the optical wavelength transmission unit 38a corresponds to the number of channels, for example 176, which can transmit in the WDM transmission apparatus #1-#6.

Further, the optical transmission and reception apparatus 33a includes e.g. 176 optical wavelength reception units 39a for exhibiting a reception function for receiving e.g. 176 monochromatic-wavelength lights. Further, the optical transmission and reception apparatus 33a includes a second control section 10b connected to both of the optical wavelength transmission units 38a described above and the optical wavelength reception units 39a for performing a wavelength setting process and so forth.

On the other hand, 176 reception ports 22b are provided on a reception portion of the WDM transmission apparatus #1. The transmission ports 21a of the optical transmission and reception apparatus 33a and the reception ports 22b of the WDM transmission apparatus #1 are connected to each other individually with the optical fibers 90.

Note that in FIG. 17 elements having numerous numbers same as the ones of elements described above is the same. A function of a plurality of photodiodes 17 and a function of laserdiode 30a can be implemented by a transmission and reception of module transmission/reception-integrated type.

By such a configuration as described above, the optical transmission and reception apparatus 33a start a wavelength allocation process. The second control section 10b operates any laserdiode 30a provided in one optical wavelength transmission units 38a (for example, the optical wavelength transmission unit #1) among optical wavelength transmission units 38a (#1-#176). In the instance, the optical transmission and reception apparatus 33a monitors the transmission ports 21a from which a monochromatic-wavelength light is transmitted and the reception ports 22a (e.g. reception port 22a paired with transmission port 21a). This control information indicates, for example, a signal representing the current wavelength is valid, or information representing the detected wavelength, or sweep control signal, or information representing a failure occurrence (signal representing invalid wavelength) etc.

Consequently, the optical transmission and reception apparatus 33a transmits, for example, a monochromatic-wavelength light outputted from the transmission port #10. At the same time, the optical transmission and reception apparatus 33a monitors an output of the reception port #10 to monitor transmission from the WDM transmission apparatus #1 of control information (information representing a detected wavelength), which represents whether or not the wavelength is detected, for a fixed period of time. Then, if a detection notification corresponding to the monochromatic-wavelength light transmitted from the optical transmission and reception apparatus 33a is received from the WDM transmission apparatus #1 within the fixed period of time, then the second control 10b drives the laser diode of the optical transmission unit #k (k represents a natural number from 1 to 176) which outputs the wavelength information of the received notification.

On the other hand, if control information from the reception port 22 is not received after the monochromatic-wavelength light is outputted from the optical transmission and reception apparatus 33a, then the monochromatic-wavelength light to be outputted is shifted such that a nest signal light is successively outputted.

Consequently, not only by the sweep output of monochromatic-wavelength lights but also by control of the outputs of the laser diodes 33a, a linked operation is performed between the optical transmission and reception apparatus 33a and the WDM transmission apparatus #1.

Since a wavelength for exclusive use is allocated for transmission of a control signal in this manner, feedback control can be performed and besides reduction in cost can be anticipated without involving a change of the locations of the existing optical fibers 90 and WDM transmission apparatuses #1 to #6 or a change of the apparatus configuration or the like.

In this manner, according to the present invention, the wavelength of each monochromatic-wavelength lights can be detected, and the wavelength allocation section 2e between the optical transmission and reception apparatus 3a and the WDM transmission apparatus #1 performs the procedures of wavelength setting and wavelength selection in an automated fashion. Accordingly, the convenience in channel allocation is improved significantly, and consequently, simplification and improvement in efficiency of the wavelength switching function can be anticipated and reduction of the cost can be achieved.

(9-6) Sixth Modification

In the optical transmission system 200 as shown FIG. 1, the optical access apparatuses 41d, 41e, 42d, 42e and the transponders 41f, 42f can be provided in the networks N1-N6 side.

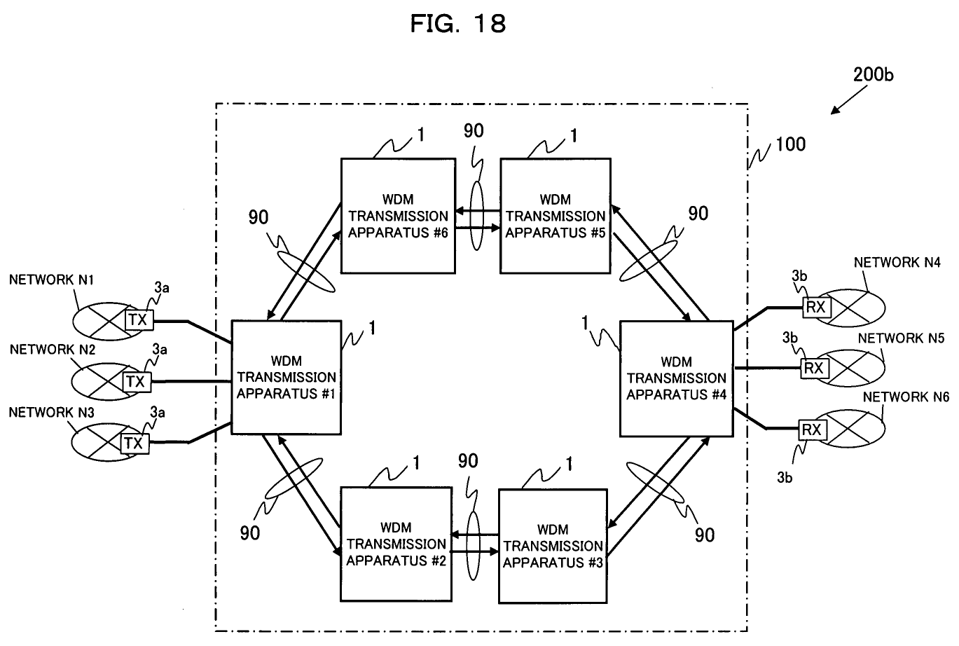

FIG. 18 is a diagrammatic view showing an example of a configuration of an optical transmission system according to the sixth modification of the first embodiment of the present invention. The optical transmission system 200b as shown in FIG. 18, connects the networks N1-N6 directly to the WDM transmission system 100, and can transmit various things, and various places.

In this manner, according to the present invention, the wavelength of each monochromatic-wavelength lights can be detected, and the wavelength allocation section 2 between the optical transmission and reception apparatus 3a and the WDM transmission apparatus #1 performs the procedures of wavelength setting and wavelength selection in an automated fashion. Accordingly, the convenience in channel allocation is improved significantly, and consequently, simplification and improvement in efficiency of the wavelength switching function can be anticipated and reduction of the cost can be achieved.

(B) Description of the Second Embodiment of the Invention

A second embodiment of the present invention is described below in regard to a method of re-setting wavelength allocation where the WDM transmission apparatus #1 is operating in a state wherein an optical fiber 90 is connected to each of the transmission ports 21a.

The optical transmission system according to the second embodiment is substantially same as the optical transmission system 200 in the first embodiment, and the transmission intervals can transmit signal lights bi-directionally.

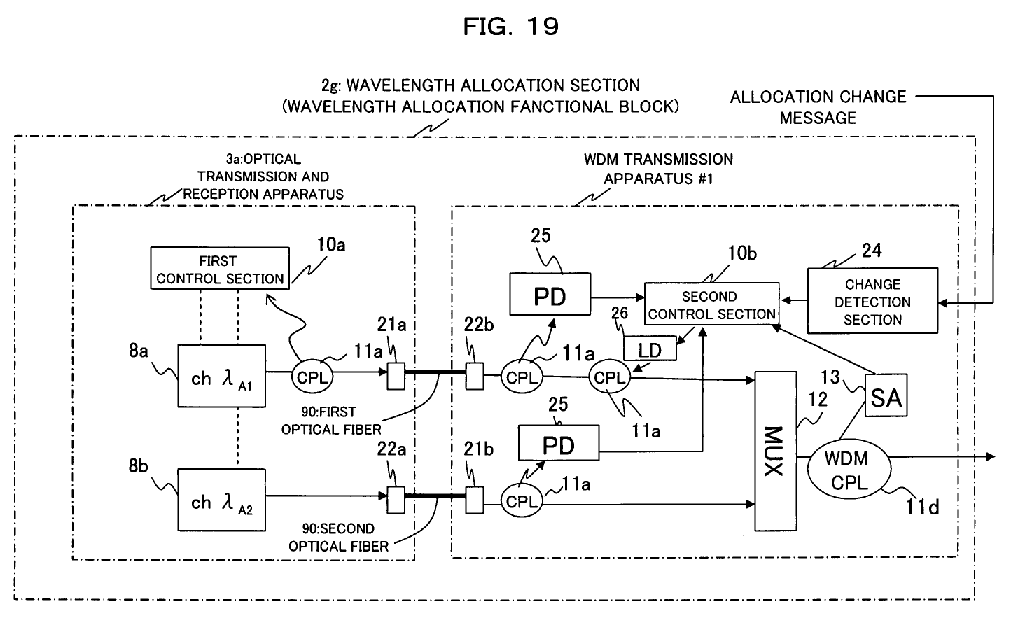

FIG. 19 is a block diagram of the wavelength allocation section 2g according to the second embodiment of the present invention. Referring to FIG. 19, the wavelength allocation section 2g comprises a part (or whole) of the optical transmission and reception apparatus 3a, and the optical fibers 90, and a part (or whole) of the WDM transmission apparatus #1. It is to be noted that the two optical fibers 90 are connected to the optical wavelength transmission units (transmission sections) 8a, 8b side, respectively, and these optical fibers 90 are also called as first optical fiber 90 and second optical fiber 90.

A function of the wavelength allocation section 2g is exhibited by cooperation of an allocation change detection section 24, a second control section 10b and notification section 33.

The allocation change detection section 24 detects a change of an allocation (allocation change request) regarding one or more monochromatic-wavelength lights from among the plural of monochromatic-wavelength lights, and the notification section 33 issues a notification of the change of the allocation which is detected by the allocation change detection section 24 to the optical wavelength transmission units (transmission sections) 8a.

The allocation change is e.g. control data included in a control light received in the WDM transmission apparatus #1, and is notified from outside of the wavelength allocation section 2g. A trigger which the allocation change is notified is, for example, in response to temporary sheltering upon occurrence of a fault on a WDM transmission line, restoration of a normal wavelength after release, sheltering for maintenance or inspection or the like.

By this notification, the wavelength allocation section 2g starts re-setting of a wavelength. The second control section 10b of the WDM transmission apparatus #1 outputs a allocation wavelength or wavelength information regarding change of allocation wavelength, and the outputted wavelength information is modulated in modulator or laserdiode 26 etc which is connected to the second control section 10b.

The modulated signal light is multiplexed in the coupler 11a (hereinafter referred to as the first coupler 11a) provided in output side of the modulator or laserdiode 26 etc. The multiplexed signal light is inputted to the optical fiber 90 through the coupler 11a (hereinafter referred to as the second coupler 11a), and notified in the reverse direction to the transmission direction (from the optical transmission and reception apparatus 3a to the WDM transmission apparatus #1), and the multiplexed signal light is superposed on the main signal and notified to the optical wavelength transmission unit (transmission section) 8a. Note that whatever the system is configured, the modulator or laserdiode 26 or coupler 11a etc can be replaced to a main signal transmission type modulator.

It is to be noted that the modulator or laserdiode 26 or coupler 11a etc can be provided not only in the optical wavelength transmission units 8a but also for the optical wavelength transmission units 8b, or the modulators etc. can be provided only in the optical wavelength transmission units 8b without providing in the optical wavelength transmission units 8b. Elements other than these apparatuses have functions similar as in those of the apparatuses.

With foregoing structure, when a wavelength allocated to a transmission port 21a is changed as a result of a change of the wavelength switching setting of the WDM transmission apparatus #1 side or the like. An example of control method for re-setting of wavelength will be described.

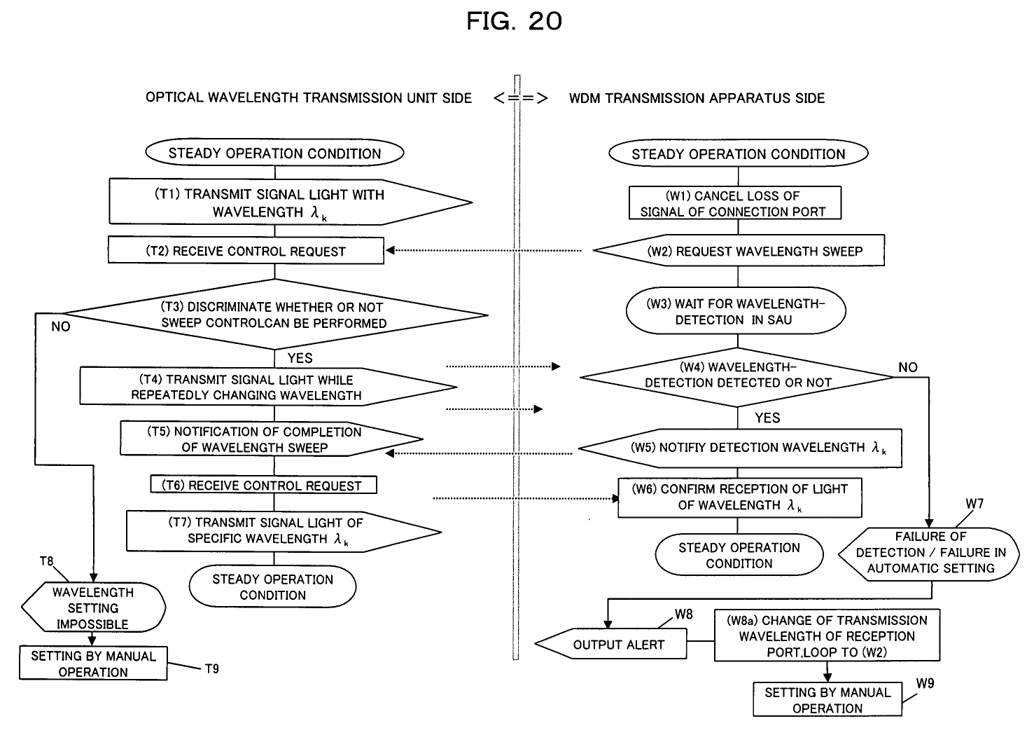

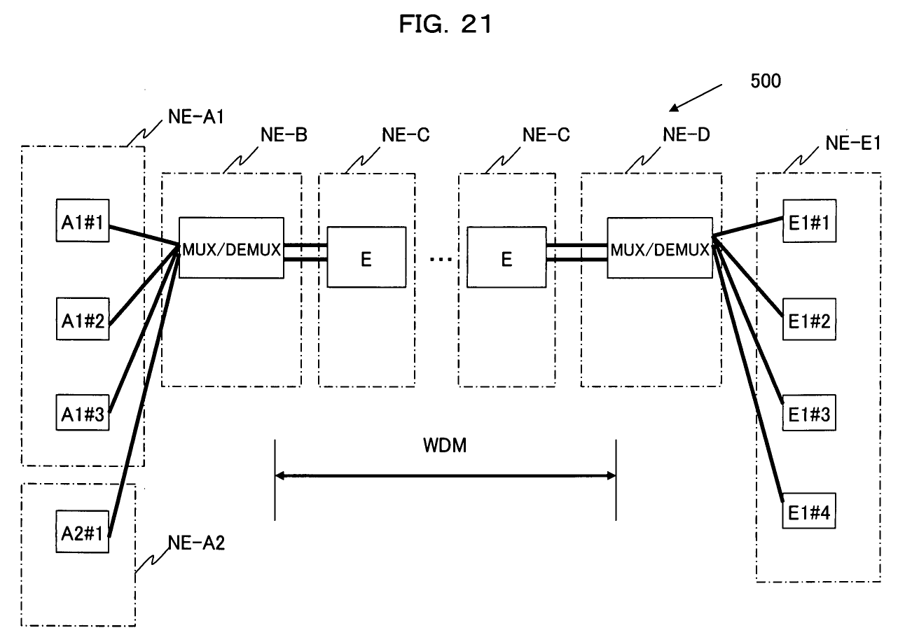

FIG. 20 is a flow chart illustrating a method of sweep control upon wavelength re-setting according to the second embodiment of the present invention.

The optical transmission and reception apparatus 3a in a steady operation condition transmits a signal light with the wavelength λ₁ (step T1). If a change of a wavelength allocated to a transmission port 21a occurs in the WDM transmission apparatus #1 (step W1), then the WDM transmission apparatus #1 transmits a wavelength sweep request for wavelength re-setting to the optical transmission and reception apparatus 3a side (step W2).

If the wavelength division multiplexing filter 12 is a filter which has a wavelength band characteristic in which a pass band has a specific wavelength band, in step W4, when the optical wavelength transmission units (transmission section) 8a, 8b sides can not wavelength sweep control or the spectrum analyzer does not detect wavelength, the processing passes the NO route, the WDM transmission apparatus #1 discriminates detection failure or automatic setting failure (step W7), outputs alarm (or alert) (step W8), after that the manual wavelength setting is operated(step W9).

On the other hand, if the wavelength division multiplexing filter 12 is a band-variable type filter, the second control section 10b changes the transmission wavelength of the reception port 22b (step W8a), the processes from step W2 is performed and the processes same as sequence SQ2 (FIG. 14) is performed.

In this manner, when a wavelength allocation, corresponding to the reception ports 22b of the WDM transmission apparatus #1 and is caused from the allocation change from the allocation change detection section 24 of the WDM transmission apparatus #1, is changed, the wavelength re-setting can be achieved similar to the automatic setting as described in the first embodiment, by that the optical wavelength transmission unit (transmission section) 8a sweeps out the emission light.

With that configuration, a function of an automatic re-configuration for which a specific wavelength is transmitted from the optical wavelength transmission units 8a is realized, and an improper connection can be automatically detected.

In this manner, the wavelength allocation section 2g according to the second embodiment of the present invention, an automatic re-configuration function for transmitting a designated wavelength from the optical transmission and reception apparatus 3a and a function of automatically detecting an inappropriate connection can be implemented.

Further, in the second embodiment of the present invention, effects, which are similar to effects as obtained in the first embodiment, can be obtained.

With the optical transmission system of the present invention, only if an optical fiber is connected to a transmission port, then wavelength setting is completed and a plug-and-play function is implemented by linked operation of an optical transmission and reception apparatus and a WDM transmission apparatus. Accordingly, wavelength allocation can be performed readily and manual operation becomes simplified, and an error in wiring is prevented.

Further, with the optical transmission and reception apparatus, after connection of an optical fiber, control, supervision and maintenance can be performed simply and conveniently and the facility can be improved significantly.

Furthermore, with the optical transmission apparatus of the present invention, wavelength setting and connection correct/wrong or connection allowance/rejection discrimination can be performed simultaneously and efficiently based on the sweep control.

Further, with the optical wavelength channel connection recognition control method of the present invention, a plurality of wavelengths can be automatically set at a time, and consequently, rapid and efficient wavelength setting can be achieved. Further, in a wavelength division multiplexing optical transmission apparatus, for example, when a transmission port is changed or a wavelength allocated to a transmission port is changed, a wavelength can be re-set. Furthermore, a re-configuration function for transmitting a designated wavelength from the optical transmission and reception apparatus and a detection function of an improper connection can be implemented.

The above and other objects, features and advantages of the present invention will become apparent from the following description and the appended claims, taken in conjunction with the accompanying drawings in which like parts or elements are denoted by like reference characters.

(C) Others

The present invention is not limited to the above-described embodiments and modifications thereof, but many variations or modifications can be effected without departing from the gist of the present invention.

Above “a downstream of the transmission direction side” indicates, as an example, the WDM transmission apparatus #1, and in addition to this WDM transmission apparatus #1, “a downstream of the transmission direction side” includes each optical add/drop apparatus (not shown) which is provided between the optical transmission and reception apparatus 3a and the WDM transmission apparatus #1 or between the optical transmission and reception apparatus 3a and the WDM transmission apparatus #4 or between the WDM transmission apparatus #4 and the optical transmission and reception apparatus 3b.

Further, each of functions of wavelength allocation sections 2a, 2b, 2c, 2d, 2e, 2g is implemented with one unit (one module) wavelength allocation apparatus having the same functions of the wavelength allocation section 2a, 2b, 2c, 2d, 2e, 2g.

1. An optical transmission system for multiplexing and transmitting a plurality of monochromatic-wavelength lights having wavelengths different from each other, comprising:
a transmission section for outputting the plural monochromatic-wavelength lights individually;
a first allocation section for allocating a wavelength of a monochromatic-wavelength light based on a power of the monochromatic-wavelength light individually outputted from said transmission section from among the plural monochromatic-wavelength lights;
a notification section for issuing a notification of wavelength information of the monochromatic-wavelength lights allocated by said first allocation section to said transmission section; and
a first control section for controlling wavelengths of the monochromatic-wavelength lights to be outputted from said transmission section based on the wavelength information of the notification issued from said notification section.

2. The optical transmission system as claimed in claim 1, wherein said first allocation section includes:
a filter (a1) capable of being set a wavelength band including a wavelength of a desired monochromatic-wavelength light from among the plural monochromatic-wavelength lights to a pass band, or (a2) having a pass characteristic of the desired monochromatic-wavelength light;
a detection section for detecting (b1) the power of monochromatic-wavelength light coincident with the pass band of said filter from among the plural monochromatic-wavelength lights individually sweep-outputted from said transmission section, or (b2) the power of monochromatic-wavelength light passing in accordance with a pass characteristic of said filter; and
a second control section for allocating wavelengths of the monochromatic-wavelength lights outputted from said transmission section based on the power of the monochromatic-wavelength light detected by said detection section.

3. The optical transmission system as claimed in claim 2, further comprising:
an allocation change detection section for detecting a change of an allocation regarding one or more monochromatic-wavelength lights from among the plural of monochromatic-wavelength lights; and
said notification section issues a notification of the change of the allocation which is detected by said allocation change detection section to said transmission section.

4. The optical transmission system as claimed in claim 2, wherein said transmission section outputs white light including the individual wavelength bands of the plural monochromatic-wavelength lights and
said detection section detects (b1) the power of a monochromatic-wavelength light coincident with the pass band of said filter from among the plural monochromatic-wavelength lights included in the white light outputted from said transmission section, or (b2) the power of monochromatic-wavelength light passing in accordance with a pass characteristic of said filter.

5. The optical transmission system as claimed in claim 1, wherein said filter has a wavelength band including a wavelength band of a desired monochromatic-wavelength light as a pass band.

6. The optical transmission system as claimed in claim 1, wherein said filter is capable of being set to a pass characteristic of a desired monochromatic-wavelength light.

7. An optical transmission system for multiplexing and transmitting a plurality of monochromatic-wavelength lights having wavelengths different from each other, comprising:
a transmission section for outputting a plurality of monochromatic-wavelength lights or white light including individual wavelength bands of the plural monochromatic-wavelength lights;
a second allocation section for allocating a channel of a monochromatic-wavelength light based on a power of a monochromatic-wavelength light individually outputted from said transmission section from among the plural monochromatic-wavelength lights or a power of the white light;
a notification section for issuing a notification of wavelength information of the monochromatic-wavelength lights allocated by said second allocation section to said transmission section; and
a first control section for controlling wavelengths of the monochromatic-wavelength lights to be outputted from said transmission section based on the wavelength information of the notification issued from said notification section.

8. An optical transmission system for multiplexing and transmitting a plurality of monochromatic-wavelength lights having wavelengths different from each other, comprising:
a first optical transmission apparatus for outputting a plurality of monochromatic-wavelength lights having wavelengths different from each other; and
a second optical transmission apparatus for multiplexing the plural monochromatic-wavelength lights outputted from said first optical transmission apparatus and transmitting the wavelength division multiplexed lights;
said first optical transmission apparatus including:
a transmission section for outputting the plural monochromatic-wavelength lights individually;
a first reception section for receiving a notification including wavelength information of monochromatic-wavelength lights allocated in the downstream of the transmission direction side from among the plural monochromatic-wavelength lights from the downstream of the transmission direction side; and
a first control section for controlling wavelengths of the monochromatic-wavelength lights to be outputted from said transmission section based on the wavelength information of the monochromatic-wavelength lights received by said first reception section,
said second optical transmission apparatus including:
a second reception section for receiving the monochromatic-wavelength lights individually outputted from said first optical transmission apparatus;
a third allocation section for allocating a wavelength of a monochromatic-wavelength light based on a power of the monochromatic-wavelength light received by said second reception section from among the plural monochromatic-wavelength lights; and
a notification section for issuing a notification of wavelength information of the monochromatic-wavelength lights allocated by said third allocation section to said first optical transmission apparatus.

9. An optical transmission and reception apparatus provided in an optical transmission system for multiplexing and transmitting a plurality of monochromatic-wavelength lights having wavelengths different from each other, comprising:
a transmission section for outputting the plural monochromatic-wavelength lights individually;
a first reception section for receiving a notification including wavelength information of monochromatic-wavelength lights allocated in a downstream of the transmission direction side from among the plural monochromatic-wavelength lights from the downstream of the transmission direction side; and
a first control section for controlling wavelengths of the monochromatic-wavelength lights to be outputted from said transmission section based on the wavelength information of the monochromatic-wavelength lights received by said first reception section.

10. An optical transmission apparatus provided in an optical transmission system for multiplexing and transmitting a plurality of monochromatic-wavelength lights having wavelengths different from each other, comprising:
a second reception section for receiving the monochromatic-wavelength lights individually outputted from the transmission side;
a third allocation section for allocating a wavelength of a monochromatic-wavelength light based on a power of the monochromatic-wavelength light received by said second reception section from among the plural monochromatic-wavelength lights; and
a notification section for issuing a notification of wavelength information of the monochromatic-wavelength lights allocated by said third allocation section to the transmission side.

11. The optical transmission apparatus as claimed in claim 10, wherein said third allocation section includes:
a filter capable of being set to a pass characteristic of a desired monochromatic-wavelength light from among the plural monochromatic-wavelength lights;
a detection section for detecting the power of at least a monochromatic-wavelength light coincident with a pass band of said filter from among the plural monochromatic-wavelength lights individually sweep-outputted from the transmission side; and
a second control section for allocating wavelengths of the monochromatic-wavelength lights based on the power of the monochromatic-wavelength light detected by said detection section.

12. The optical transmission apparatus as claimed in claim 10, further comprising:
an allocation change detection section for detecting a change of a wavelength an allocation regarding one or more monochromatic-wavelength lights from among the plural of monochromatic-wavelength lights; and
said notification section issues a notification of the change of the allocation which is detected by said allocation change detection section to said transmission section.

13. An optical wavelength channel connection recognition control method between an optical transmission and reception apparatus and an optical transmission apparatus in an optical transmission system for multiplexing and transmitting a plurality of monochromatic-wavelength lights having wavelengths different from each other, comprising the steps of:
at said optical transmission apparatus, transmitting a control request to said optical transmission and reception apparatus based on a connection of an optical fiber or a change of wavelength allocation in the downstream of the transmission direction side;
at said optical transmission and reception apparatus, individually sweep-outputting the plural monochromatic-wavelength lights;
at said optical transmission apparatus, monitoring the output power of a filter capable of setting a wavelength of a desired monochromatic-wavelength light as a pass band to detect the desired monochromatic-wavelength light;
said optical transmission apparatus, issuing a notification of wavelength information of the detected monochromatic-wavelength light to said optical transmission and reception apparatus; and
at said optical transmission and reception apparatus, outputting the desired monochromatic-wavelength light based on the wavelength information.

14. A wavelength allocation apparatus provided in an optical transmission system for multiplexing and transmitting a plurality of monochromatic-wavelength lights having wavelengths different from each other, comprising:
a transmission section for outputting the plural monochromatic-wavelength lights individually;
a first allocation section for allocating a wavelength of a monochromatic-wavelength light based on a power of the monochromatic-wavelength light individually outputted from said transmission section from among the plural monochromatic-wavelength lights;
a notification section for issuing a notification of wavelength information of the monochromatic-wavelength lights allocated by said first allocation section to said transmission section; and
a first control section for controlling wavelengths of the monochromatic-wavelength lights to be outputted from said transmission section based on the wavelength information of the notification issued from said notification section.

15. The wavelength allocation apparatus as claimed in claim 14, wherein said first allocation section includes:
a second reception section for receiving the monochromatic-wavelength lights individually outputted from the transmission side;
a filter capable of being set to a pass characteristic of a desired monochromatic-wavelength light from among the plural monochromatic-wavelength lights;
a detection section for detecting the power of at least a monochromatic-wavelength light coincident with a pass band of said filter from among the plural monochromatic-wavelength lights individually sweep-outputted from said transmission section; and
a second control section for allocating wavelengths of the monochromatic-wavelength lights based on the power of the monochromatic-wavelength light detected by said detection section.

16. The wavelength allocation apparatus as claimed in claim 14, wherein said notification section issues the notification of the wavelength information of the monochromatic-wavelength light to said transmission section through an optical transmission line along which main signal light is transmitted.

17. The wavelength allocation apparatus as claimed in claim 16, wherein said notification section issues the notification of the wavelength information of the monochromatic-wavelength light to said transmission section through a plurality of different ports individually corresponding to said plural ports.

18. The wavelength allocation apparatus as claimed in claim 14, wherein said notification section issues the notification of the wavelength information of the monochromatic-wavelength light to said transmission section through a communication line for network monitoring.
